(19) United States
(12) Patent Application Publication
(10) Pub. No.: US 2013/0193263 A1
(43) Pub. Date: Aug. 1, 2013

(54) ROADABLE AIRCRAFT AND RELATED SYSTEMS

(71) Applicants: Samuel Adam Schweighart, Belmont, MA (US); Andrew Heafitz, Cambridge, MA (US); Gregor Cadman, Oakland, CA (US); Benjamin Zelnick, Somerville, MA (US); Marc Stiller, Watertown, MA (US); Anna Dietrich, Woburn, MA (US); Carl Curtis Dietrich, Woburn, MA (US)

(72) Inventors: Samuel Adam Schweighart, Belmont, MA (US); Andrew Heafitz, Cambridge, MA (US); Gregor Cadman, Oakland, CA (US); Benjamin Zelnick, Somerville, MA (US); Marc Stiller, Watertown, MA (US); Anna Dietrich, Woburn, MA (US); Carl Curtis Dietrich, Woburn, MA (US)

(21) Appl. No.: 13/811,789

(22) PCT Filed: Jul. 22, 2011
(86) PCT No.: PCT/US11/45059

§ 371 Date: Apr. 4, 2013

Related U.S. Application Data
(60) Provisional application No. 61/367,237, filed on Jul. 23, 2010.

(51) Int. Cl. B64C 37/00; B64C 3/56; F01D 5/12

(52) U.S. Cl. CPC B64C 37/00; F01D 5/12; B64C 3/56
USPC 244/2; 416/225; 244/49

(57) ABSTRACT

The invention relates to a roadable aircraft vehicle (100) and related systems. An example roadable aircraft vehicle (100) includes a vehicle drive system (262) including an engine (264) and gearbox (206) selectively engageable with an automotive driveline (266) and at least one propeller (270), a user interface including a display (202) for controlling the drive system (262) in an automotive mode including a steering wheel (204) and in a flight mode including a control stick (272), a control system for switching between the flight mode and the automotive mode, and a system (236) for locking the propeller (270) during the automotive mode. The invention also relates to aircraft systems and elements such as an airfoil (106) having a nominal profile, a folding wing (102), and an occupant crash protection system for an aircraft (100).

### CROSS-REFERENCE TO RELATED APPLICATIONS

This application claims priority to and the benefit of U.S. Provisional Patent Application Ser. No. 61/367,237, filed Jul. 23, 2010. This application is related to U.S. patent application Ser. No. 11/650,346, filed Jan. 5, 2007, U.S. patent application Ser. No. 12/177,849, filed Jul. 22, 2008, and U.S. patent application Ser. No. 12/177,861, filed Jul. 22, 2008. The disclosures of all the above-identified applications are hereby incorporated herein by reference in their entirety.

### FIELD OF THE INVENTION

The present invention relates generally to the field of roadable aircraft and, more particularly, to an aircraft that can be converted into an automotive-type vehicle capable of driving on the road and related systems for such a vehicle.

### BACKGROUND OF THE INVENTION

While a number of roadable aircraft designs have been contemplated or produced, these designs have in general been impractical for use as general purpose driving and flying vehicles capable of meeting road and air vehicle safety standards.

### SUMMARY OF THE INVENTION

The present invention is directed towards novel roadable aircraft and related systems for such vehicles.

One aspect of the invention relates to a roadable aircraft vehicle. The vehicle includes a vehicle drive system including an engine and gearbox selectively engageable with an automotive driveline and at least one propeller, a user interface including a display for controlling the drive system in an automotive mode including a steering wheel and in a flight mode including a control stick, a control system for switching between the flight mode and the automotive mode, and apparatus for locking the propeller during the automotive mode. The automotive driveline may include a continuously variable transmission.

In one embodiment, the propeller is lockable in a set position adapted to maximize ground clearance during the automotive mode. The control stick may be adapted to pivot into a stowed position, or to telescopingly collapse into a stowed position during the automotive mode. In one embodiment, the control system may switch between flight mode and automotive mode by alternatively coupling the gearbox to the automotive driveline, for the automotive mode, and coupling the gearbox to the propeller, for the flight mode.

The vehicle may include a folding wing and the control system may include structure for deploying and retracting the folding wing. The structure for deploying and retracting the folding wing may include a folding mechanism activated by a manipulation of an automotive gear shift lever. The control system may include apparatus for disabling an automotive gas pedal during the flight mode and/or for disabling a throttle during the automotive mode.

In one embodiment, the vehicle includes a data storage unit adapted to record control and/or performance data during at least one of the flight mode and the automotive mode. The vehicle may also include a transponder. The display may be adapted to display selectively both automotive control data and/or flight control data. The display may include a touch-screen. The vehicle may include at least one stabilator and a system for deflecting the stabilator to provide a down-force during the automotive mode. In one embodiment, the vehicle includes an electronically actuated parking brake, which may, for example, be activated upon removal of an ignition key.

Another aspect of the invention includes an airfoil having a nominal profile. The airfoil includes a leading edge, a trailing edge, an upper surface extending from the leading edge to the trailing edge, and a lower surface extending from the leading edge to the trailing edge and having a substantially flat portion extending over at least about 50% of a chord length of the airfoil, wherein the airfoil has a moment coefficient magnitude of less than about 0.045 and a maximum lift coefficient of greater than about 1.95. In one embodiment, the nominal profile conforms substantially with Cartesian coordinate values of (X,Y) set forth in Table 1, wherein X and Y are non-dimensional distances which, when connected by smooth continuing arcs, define an airfoil profile section.

Another aspect of the invention includes a folding wing. The folding wing includes an inner section extendable from a fuselage of an aircraft, the inner section having a root end pivotably couplable to the fuselage through a first pivoting mechanism and a distal end. The folding wing also includes an outer section pivotably coupled to the inner section distal end by a second pivoting mechanism and a folding mechanism adapted to articulate the first pivoting mechanism and the second pivoting mechanism to move the wing between a stowed configuration and a deployed configuration, at least one of the first pivoting mechanism and second pivoting mechanism including a four-bar linkage. In one embodiment, the inner section is extendable from a fuselage of a roadable aircraft.

In one embodiment, a portion of at least one of the inner section and the outer section includes a cross-sectional airfoil shape including a leading edge, a trailing edge, an upper surface extending from the leading edge to the trailing edge, and a lower surface extending from the leading edge to the trailing edge and having a substantially flat portion extending over at least about 50% of a chord length of the airfoil, wherein the airfoil has a moment coefficient magnitude of less than about 0.045 and a maximum lift coefficient of greater than about 1.95.

At least one of the inner section and the outer section may include at least one measurement device extending from a lower surface thereof. The wing may form a cavity on a lower surface thereof to conformingly enclose the at least one measurement device therein upon folding of the wing into the stowed configuration. The cavity may include at least one covering element adapted to substantially cover the cavity when the wing is deployed.

In one embodiment, the root end of the wing includes a covering portion adapted to at least partially cover the first pivoting mechanism when the wing is in the stowed configuration. The folding wing may include a latching element adapted to provide a releasable locking element to lock the wing in the stowed configuration. The latching element may be adapted to provide an anchoring location for releasably anchoring the wing to a ground support when in the deployed configuration.

The folding mechanism may include at least one push-pull cable adapted to control deflection of at least one control surface. The push-pull cable may extend within the inner section and the outer section, and/or may include a twisting section extending between the inner section and outer section. The folding mechanism may include a push-rod mechanism adapted to assist in deployment and retraction of the wing. The folding wing may, in one embodiment, include at least one of a collision sensor, a range detector, and/or a laser outline system.

Another aspect of the invention includes an occupant crash protection system for an aircraft. The occupant crash protection system includes a frame forming a passenger compartment safety cage and a forward crumple zone located in front of the passenger compartment safety cage. The forward crumple zone may include at least two elongate rails coupled at a rear end to the frame and a hollow substantially rigid cross member coupled to a front distal end of each of the at least two elongate rails. The crash protection system may be adapted for use in a roadable aircraft.

In one embodiment, at least one of the hollow substantially rigid cross member and the at least two elongate rails are made of a metal, a plastic, and/or a composite material. The metal may, for example, include, or consist essentially of, aluminum. The crash protection system may include a collapsible, energy absorbing tail structure located at the rear of the aircraft. The collapsible, energy absorbing tail structure may be adapted to provide protection to at least one of an occupant of the aircraft and a fuel tank of the aircraft when in an automotive mode. In one embodiment, the collapsible, energy absorbing tail structure includes a conical, progressively crumpling structure.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a perspective view of a roadable aircraft vehicle in a flight mode, in accordance with one embodiment of the invention;

FIG. 1B is a front view of the roadable aircraft vehicle of FIG. 1A;

FIG. 1C is a rear view of the roadable aircraft vehicle of FIG. 1A;

FIG. 1D is a left-side view of the roadable aircraft vehicle of FIG. 1A;

FIG. 1E is a right-side view of the roadable aircraft vehicle of FIG. 1A;

FIG. 1F is a top view of the roadable aircraft vehicle of FIG. 1A;

FIG. 1G is a bottom view of the roadable aircraft vehicle of FIG. 1A;

FIG. 2A is a perspective view of a roadable aircraft vehicle during transition between a flight mode and an automotive mode, in accordance with one embodiment of the invention;

FIG. 2B is a front view of the roadable aircraft vehicle of FIG. 2A;

FIG. 2C is a rear view of the roadable aircraft vehicle of FIG. 2A;

FIG. 2D is a left-side view of the roadable aircraft vehicle of FIG. 2A;

FIG. 2E is a right-side view of the roadable aircraft vehicle of FIG. 2A;

FIG. 2F is a top view of the roadable aircraft vehicle of FIG. 2A;

FIG. 2G is a bottom view of the roadable aircraft vehicle of FIG. 2A;

FIG. 3A is a perspective view of a roadable aircraft vehicle in an automotive mode, in accordance with one embodiment of the invention;

FIG. 3B is a front view of the roadable aircraft vehicle of FIG. 3A;

FIG. 3C is a rear view of the roadable aircraft vehicle of FIG. 3A;

FIG. 3D is a left-side view of the roadable aircraft vehicle of FIG. 3A;

FIG. 3E is a right-side view of the roadable aircraft vehicle of FIG. 3A;

FIG. 3F is a top view of the roadable aircraft vehicle of FIG. 3A;

FIG. 3G is a bottom view of the roadable aircraft vehicle of FIG. 3A;

FIG. 4 is an airfoil shape of a folding wing of a roadable aircraft vehicle, in accordance with one embodiment of the invention;

FIG. 5 is a table (TABLE 1) of non-dimensional (X,Y) coordinates for an airfoil, in accordance with one embodiment of the invention;

FIG. 6A is a plot of Pressure Coefficient against x-location for an airfoil, in accordance with one embodiment of the invention;

FIG. 6B is another plot of Pressure Coefficient against x-location for an airfoil, in accordance with one embodiment of the invention;

FIG. 6C is a plot of Lift Coefficient and Moment Coefficient for an airfoil, in accordance with one embodiment of the invention;

FIG. 7A is a schematic top view of a folding wing in a deployed position, in accordance with one embodiment of the invention;

FIG. 7B is a schematic side view of a folding wing in a retracted position, in accordance with one embodiment of the invention;

FIG. 7C is a schematic side view of a folding wing with a push-pull cable in a retracted position, in accordance with one embodiment of the invention;

FIG. 7D is a schematic top view of a folding wing with a push-pull cable in a deployed position, in accordance with one embodiment of the invention;

FIG. 7E is a perspective view of a wing tip of a deployed folding wing having a latching element, in accordance with one embodiment of the invention;

FIG. 7F is a perspective view of a wing tip of a retracted folding wing having a latching element, in accordance with one embodiment of the invention;

FIG. 7G is a bottom view of the wing tip of the retracted folding wing and latching element of FIG. 7F;

FIG. 8A is a schematic perspective view of a roadable aircraft vehicle having a laser outline system for a folding wing, in accordance with one embodiment of the invention;

FIG. 8B is a schematic perspective view of the roadable aircraft vehicle of FIG. 8A transitioning from an automotive mode to a flight mode;

FIG. 8C is a schematic perspective view of the roadable aircraft vehicle of FIG. 8A in a flight mode;

FIG. 9A is a side view of a stabilator of a roadable aircraft vehicle having a folding license plate, in accordance with one embodiment of the invention;

FIG. 9B is a front view of the stabilator of FIG. 9A;

FIG. 10A is a schematic top view of a retracting mirror for a roadable aircraft vehicle in a deployed position, in accordance with one embodiment of the invention;

FIG. 10B is a schematic top view of the retracting mirror of FIG. 10A in a retracted position;

FIG. 11A is a schematic perspective view of a crushable front impact energy absorber for a roadable aircraft vehicle, in accordance with one embodiment of the invention;

FIG. 11B is another schematic perspective view of the crushable front impact energy absorber of FIG. 11A;

FIG. 11C is a schematic top view of a roadable aircraft vehicle undergoing a side impact collision, in accordance with one embodiment of the invention;

FIGS. 12A to 12D are perspective views of a passenger compartment of a roadable aircraft vehicle, in accordance with one embodiment of the invention;

FIGS. 13A to 13D are perspective views of an interior of a passenger compartment of a roadable aircraft vehicle, in accordance with one embodiment of the invention;

FIG. 14A is a schematic sectional side view of a gearbox for a roadable aircraft vehicle, in accordance with one embodiment of the invention;

FIG. 14B is another schematic side view of the gearbox of FIG. 14A;

FIG. 15 is a schematic perspective of a propeller locking mechanism, in accordance with one embodiment of the invention;

FIG. 16A is a schematic perspective view of a shift lever mechanism for a roadable aircraft vehicle, in accordance with one embodiment of the invention;

FIG. 16B is another schematic perspective view of the shift lever mechanism of FIG. 16A;

FIG. 17A is a flowchart of a roadable aircraft vehicle drive system in flight mode, in accordance with one embodiment of the invention;

FIG. 17B is a flowchart of the roadable aircraft vehicle drive system of FIG. 17A in automotive mode,

FIG. 18A is a schematic perspective view of a stowable control stick for a roadable aircraft vehicle in a stowed position, in accordance with one embodiment of the invention;

FIG. 18B is a schematic side view of the stowable control stick of FIG. 18A positioned within a vehicle passenger compartment in a stowed position;

FIG. 18C is a schematic side view of the stowable control stick of FIG. 18A positioned within a vehicle passenger compartment in a deployed position;

FIG. 19A is a schematic perspective view of a steering centering system for a roadable aircraft vehicle, in accordance with one embodiment of the invention; and

FIG. 19B is a schematic perspective view of a pulley of the steering centering system of FIG. 19A.

### DETAILED DESCRIPTION OF THE INVENTION

Various embodiments of the invention relate to roadable aircraft vehicle for use as general purpose driving and flying vehicles that meet all relevant road and air vehicle safety standards. Various embodiments of the invention described herein also relate to various systems, and related methods of operation and manufacture, for incorporation into such vehicles.

Vehicle

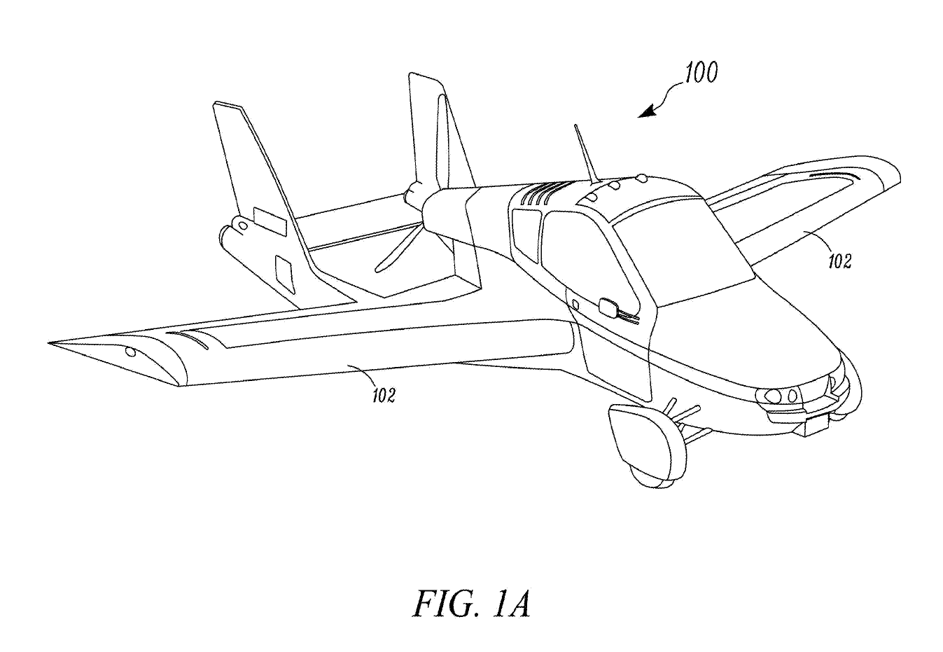

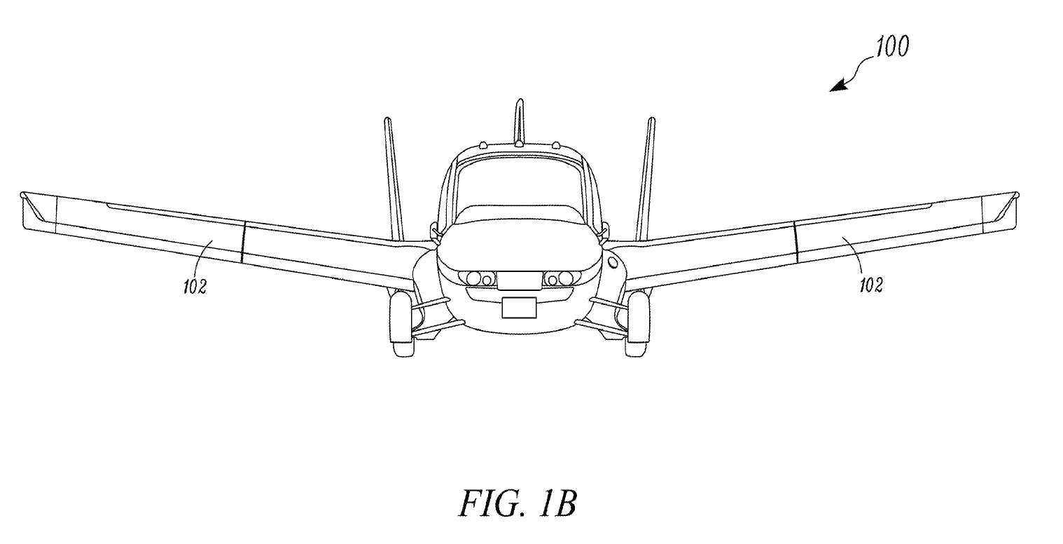

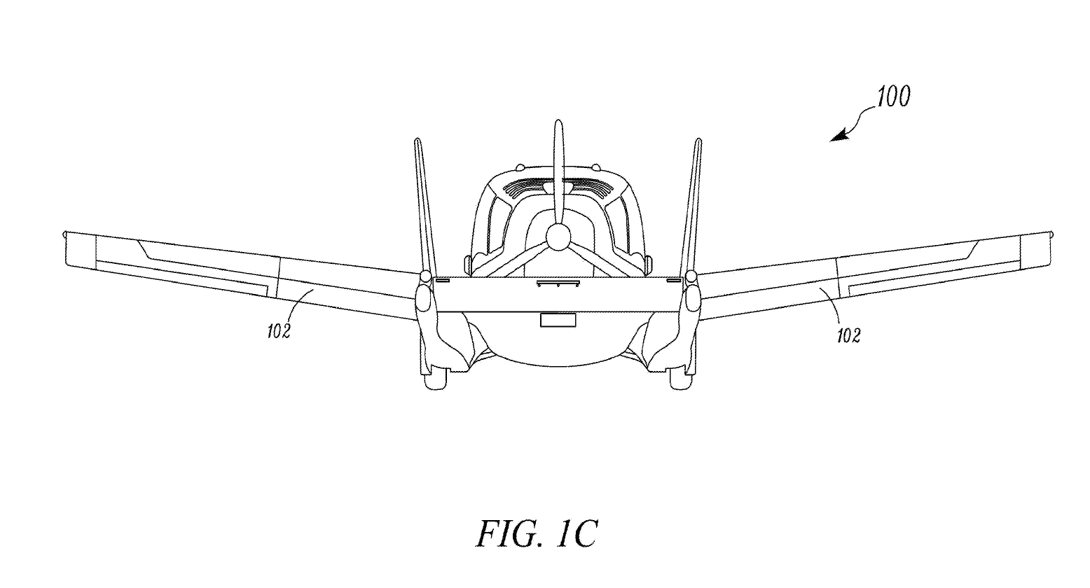

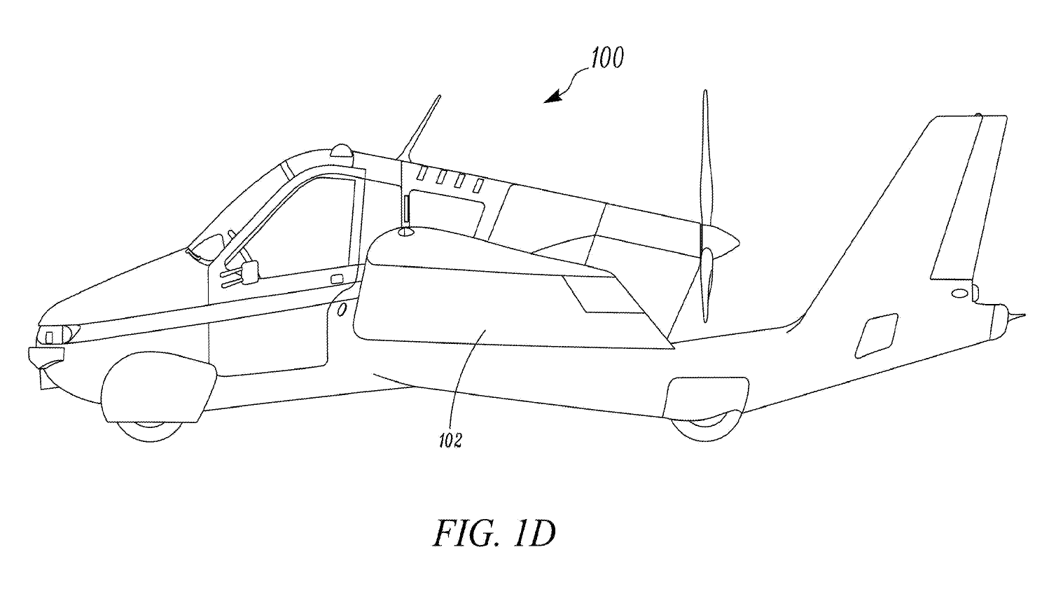

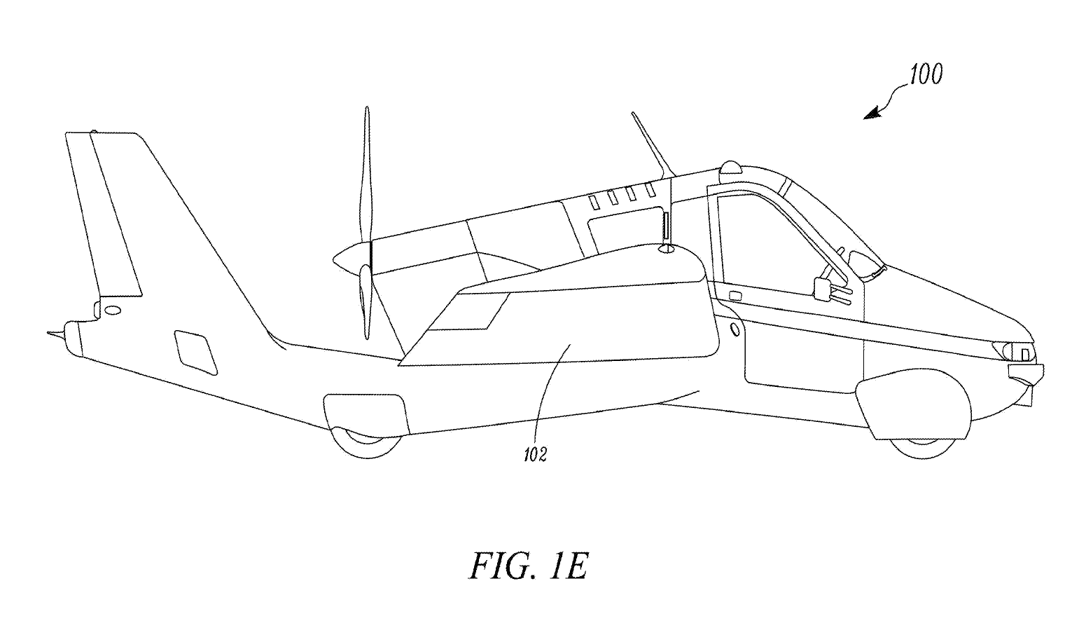

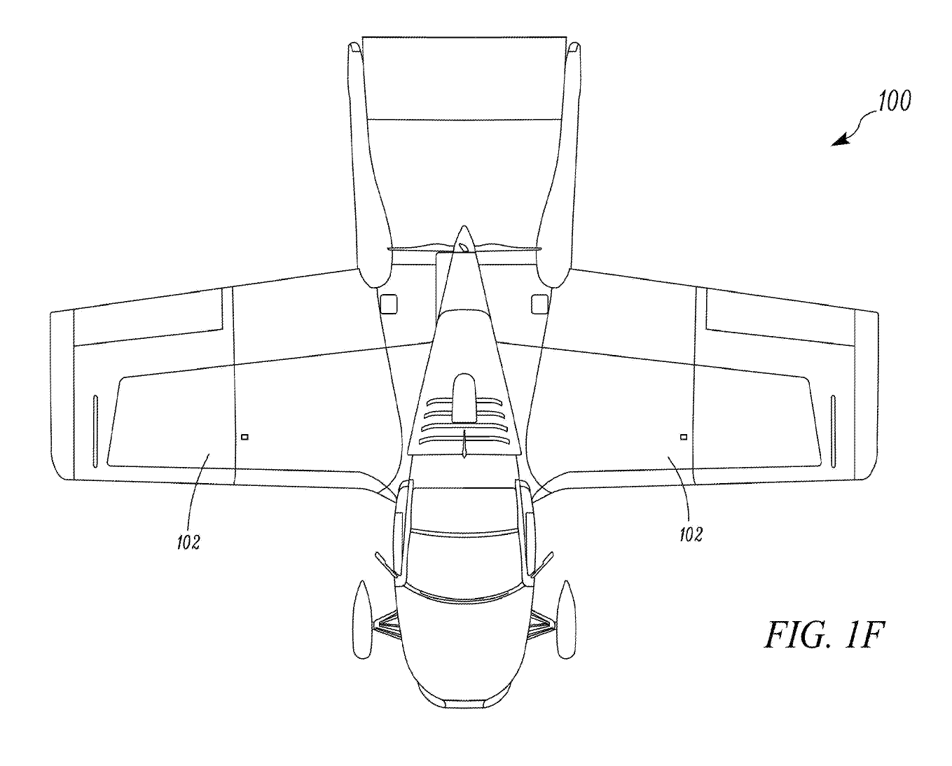

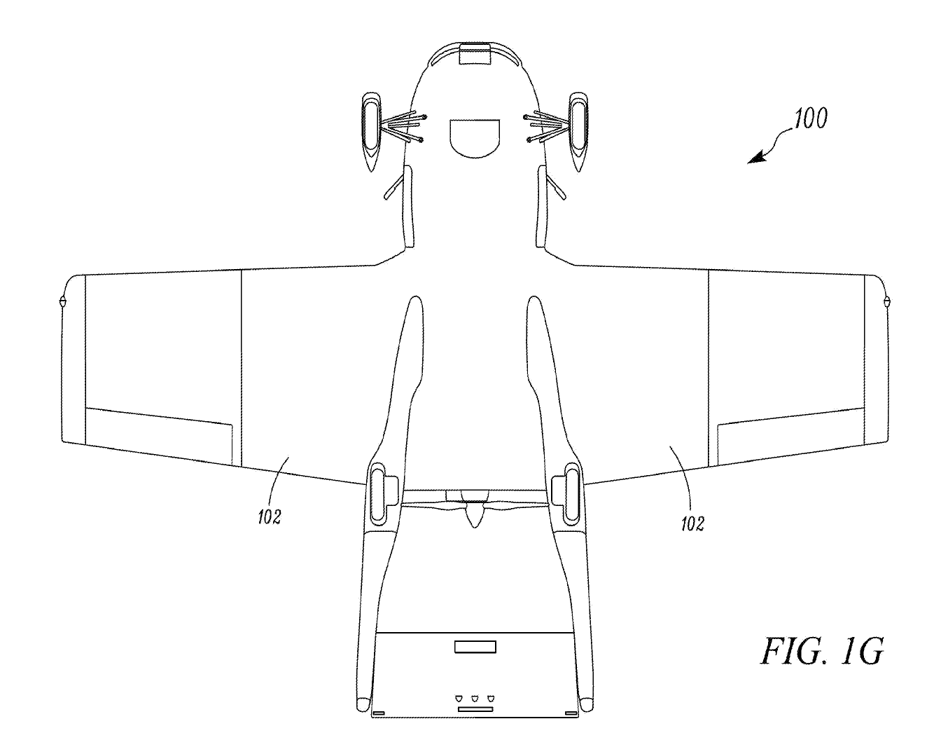

FIGS. 1A-3G show an exemplary roadable aircraft vehicle 100 (herein after interchangeably referred to as vehicle 100) that may transition from a flight mode, with folding wings 102 (herein after interchangeably referred to as wings 102) extended, to an automotive mode, with folding wings 102 retracted. As shown in the FIG. 1A, the roadable aircraft vehicle 100 is in the flight mode having the folding wings 102 extended in an outward direction. FIGS. 1B-1G show a front view, rear view, left-side view, right side view, top view, and bottom view, respectively, of the roadable aircraft vehicle 100 in the flight mode.

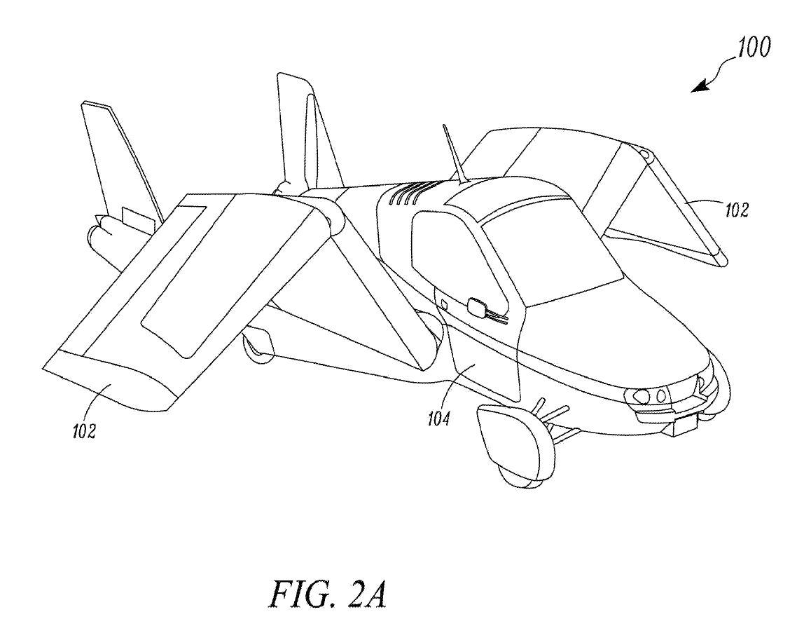

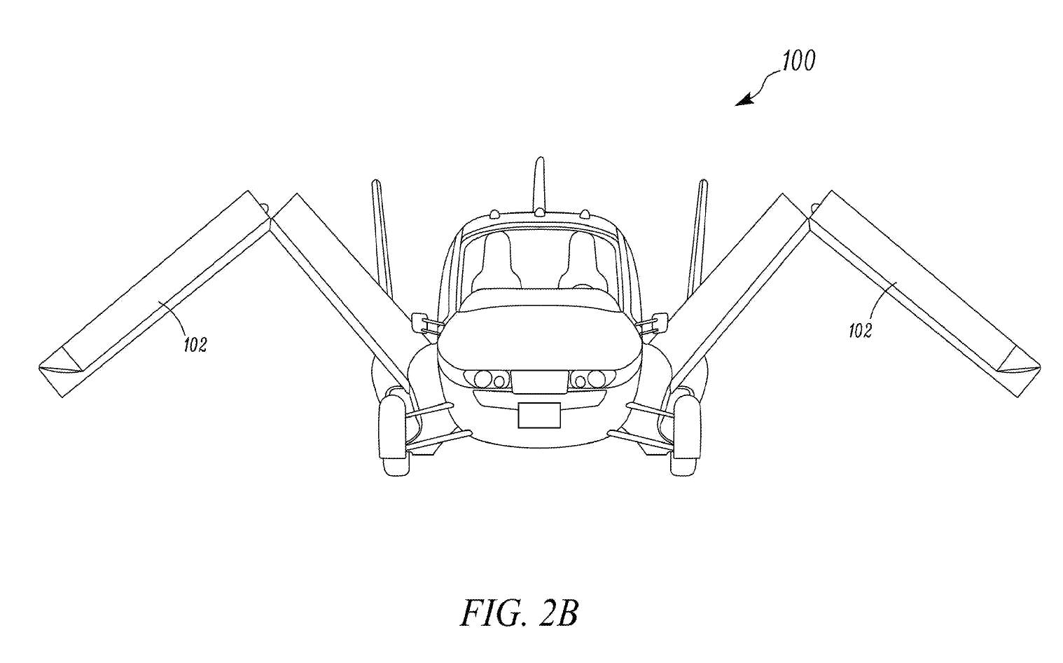

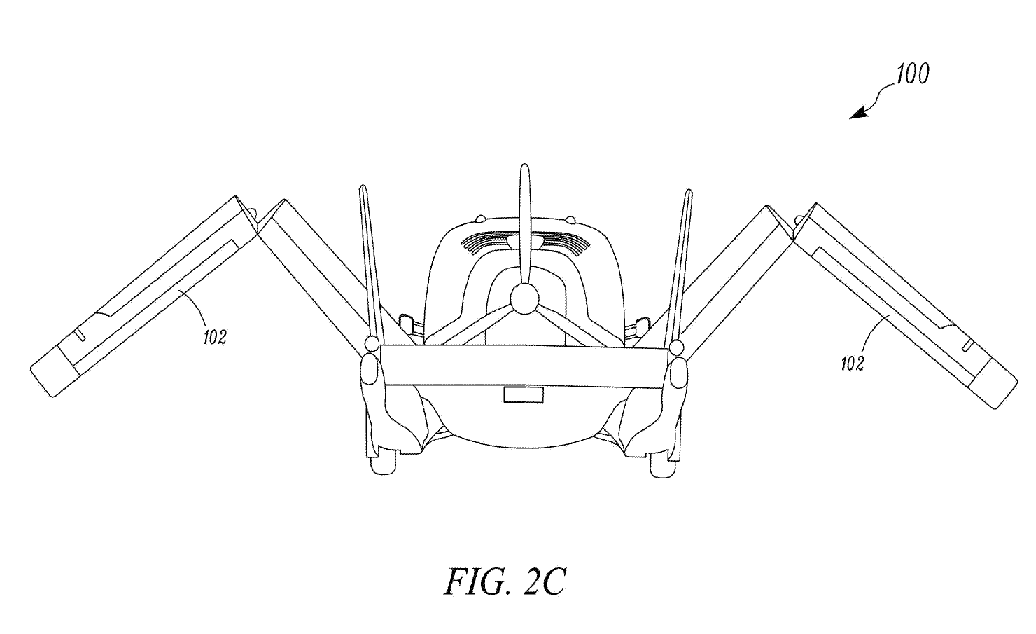

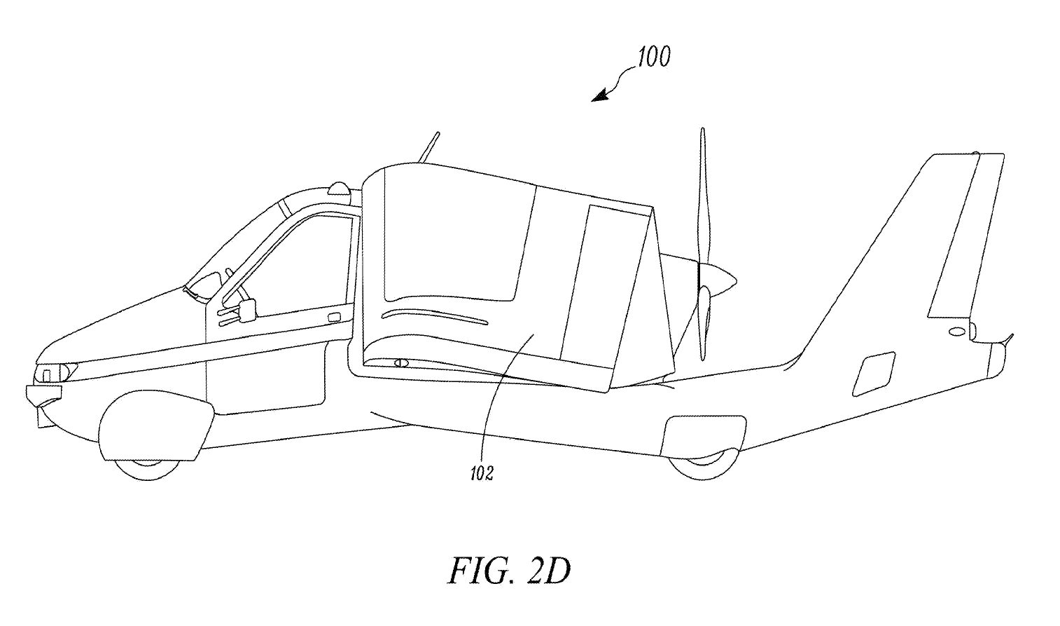

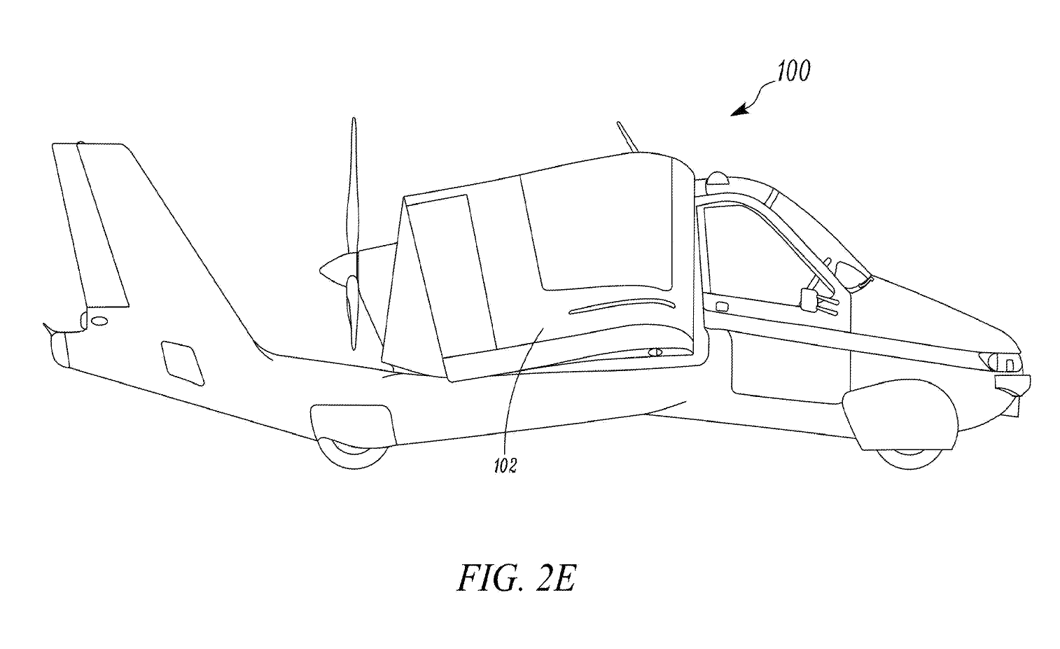

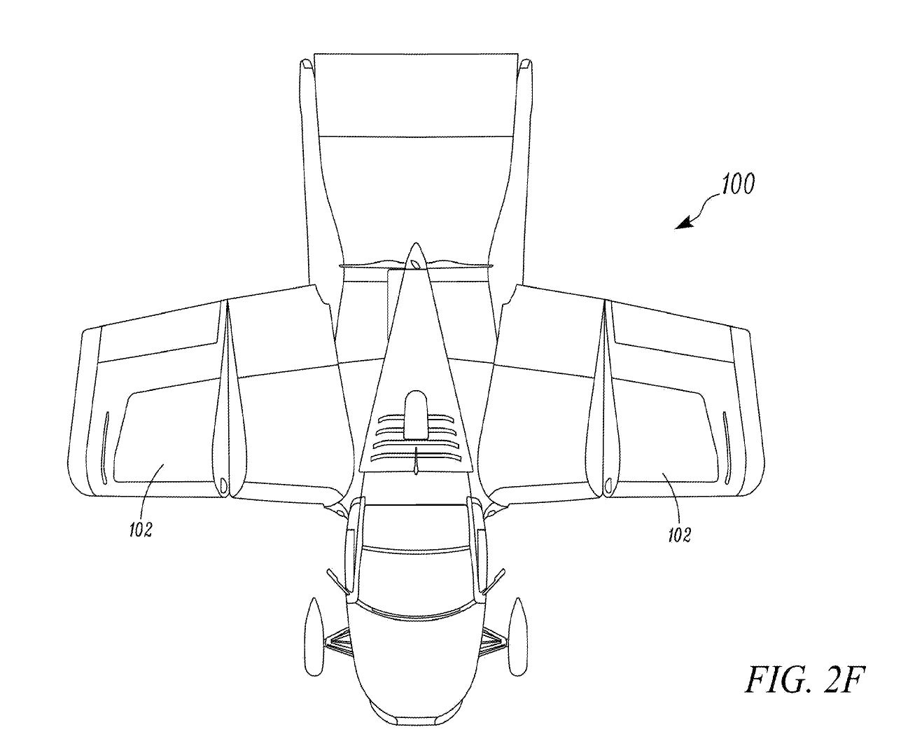

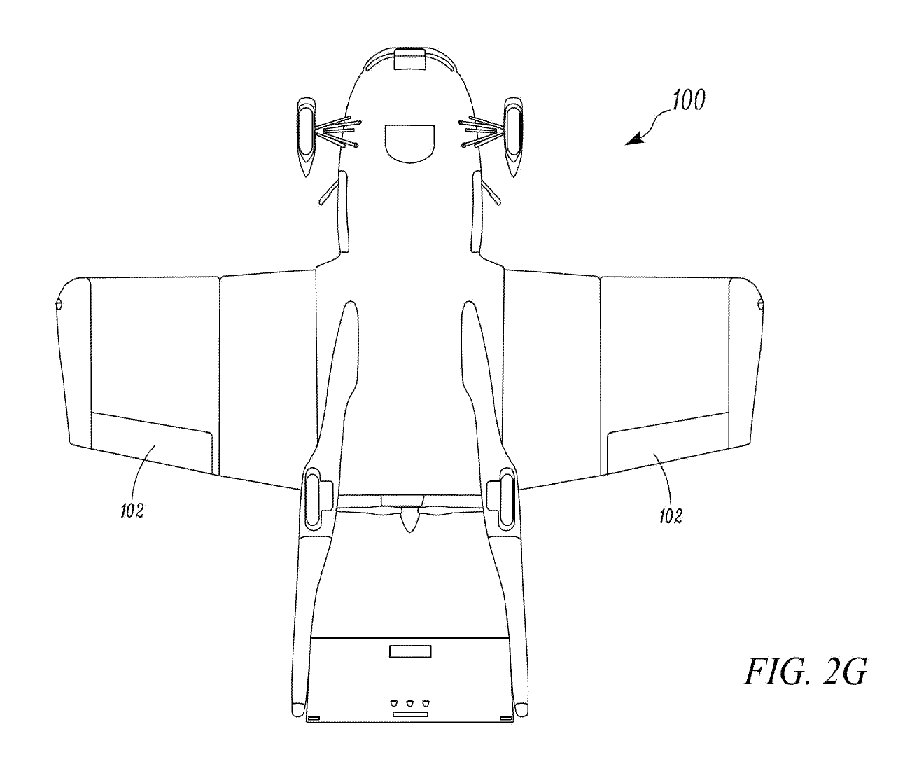

The roadable aircraft vehicle 100 is depicted in FIG. 2A during a transition between the flight mode and the automotive mode. During the transition from flight to automotive mode, the wings 102 are retracted towards a body 104 of the roadable aircraft vehicle 100. FIGS. 2B-2G show a front view, rear view, left-side view, right side view, top view, and bottom view, respectively, of the roadable aircraft vehicle 100 in the transition from the flight mode to the automotive mode.

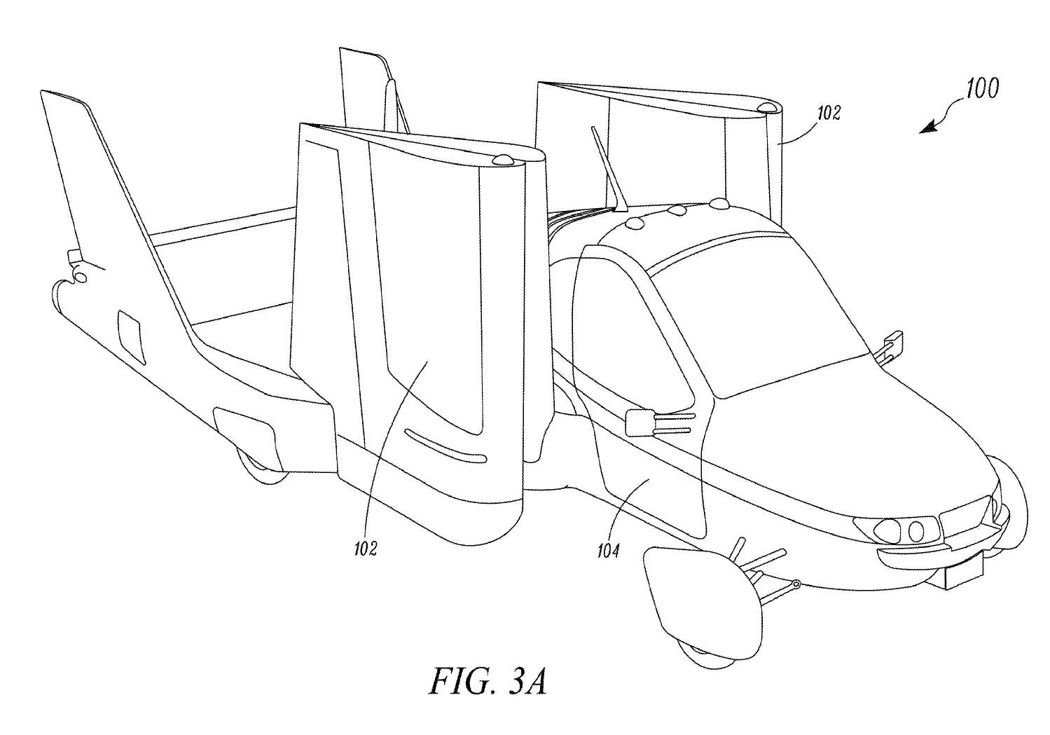

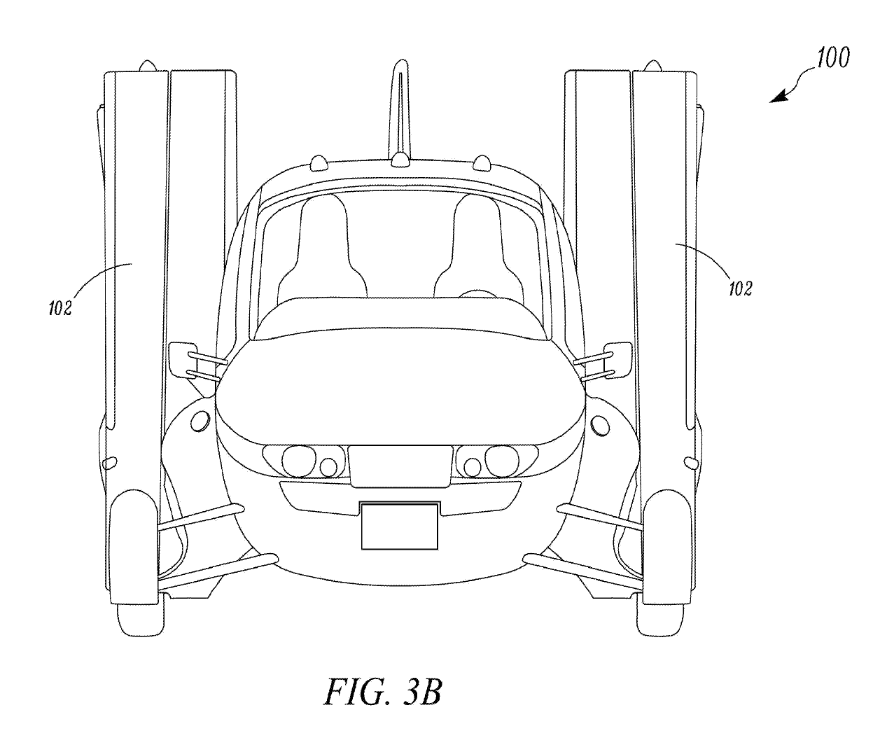

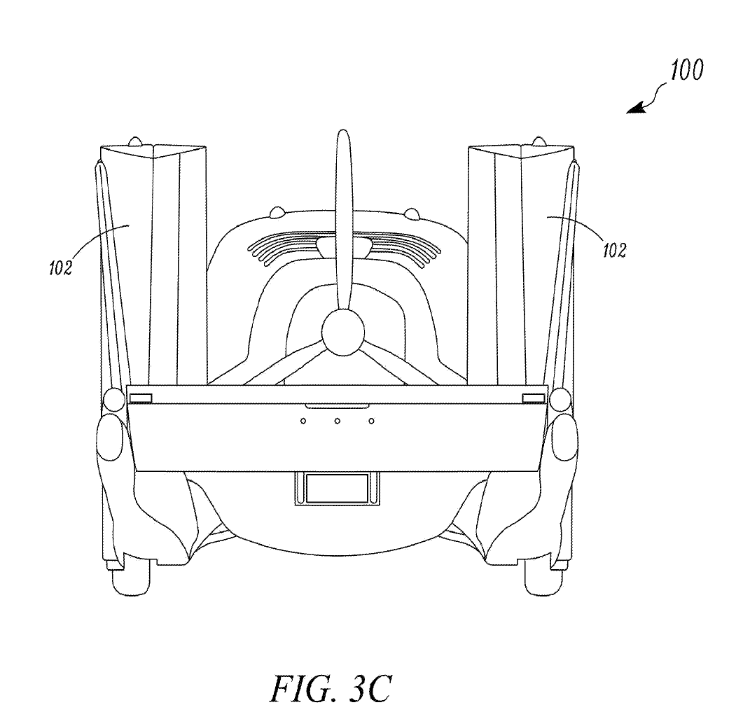

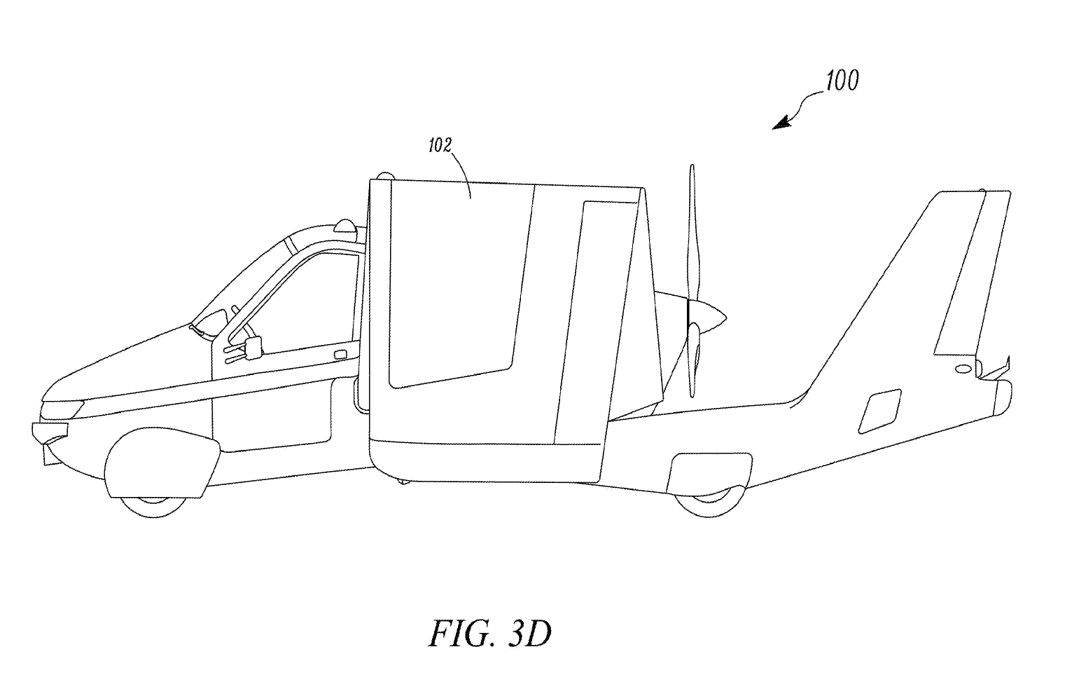

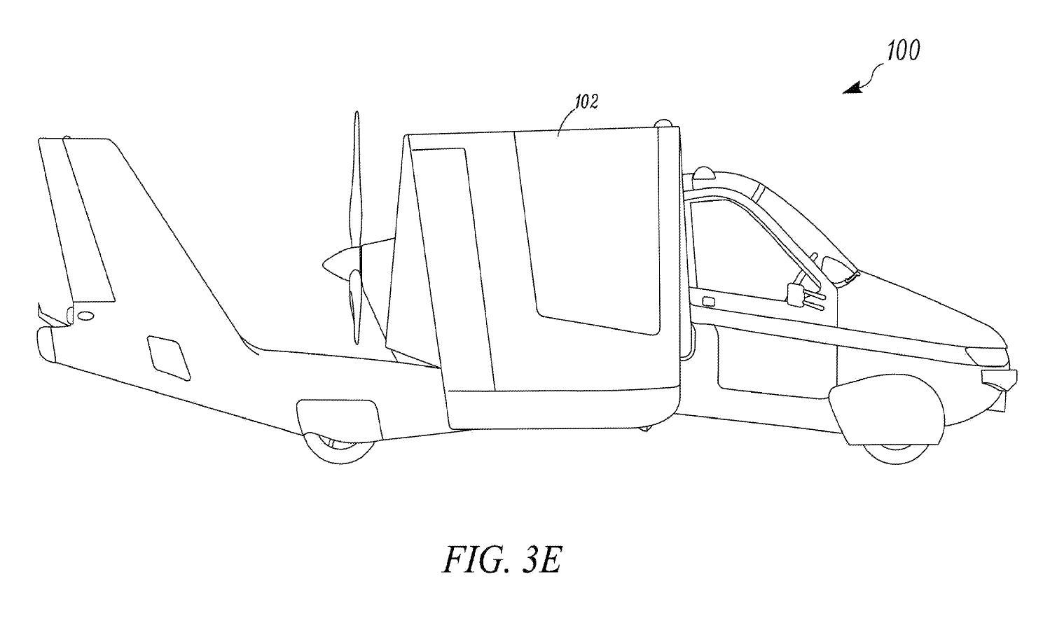

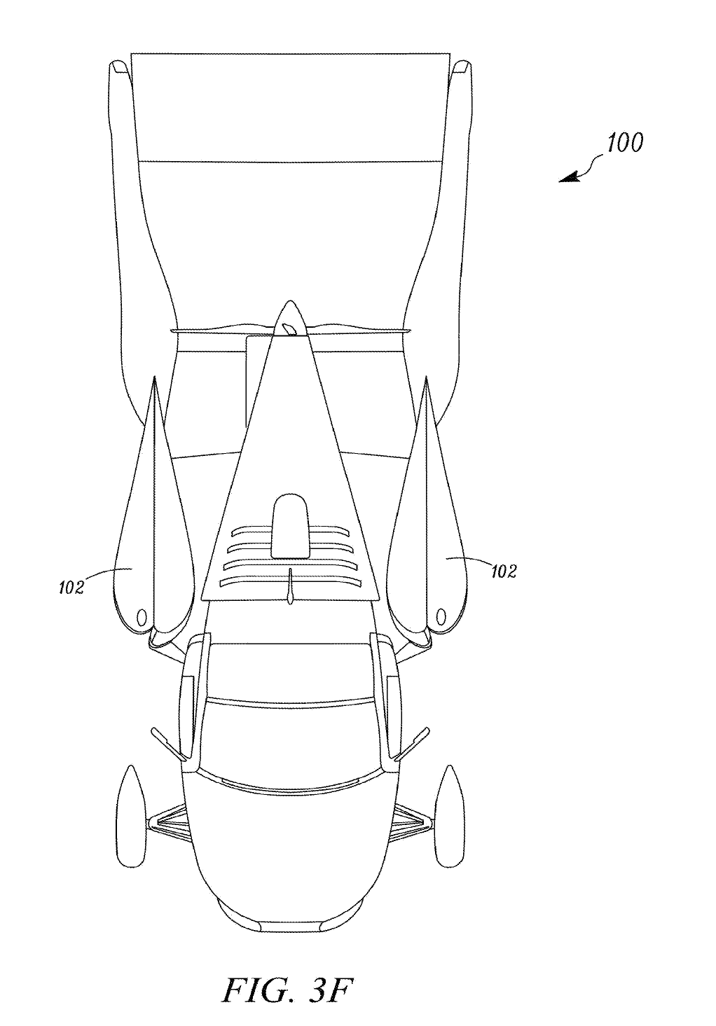

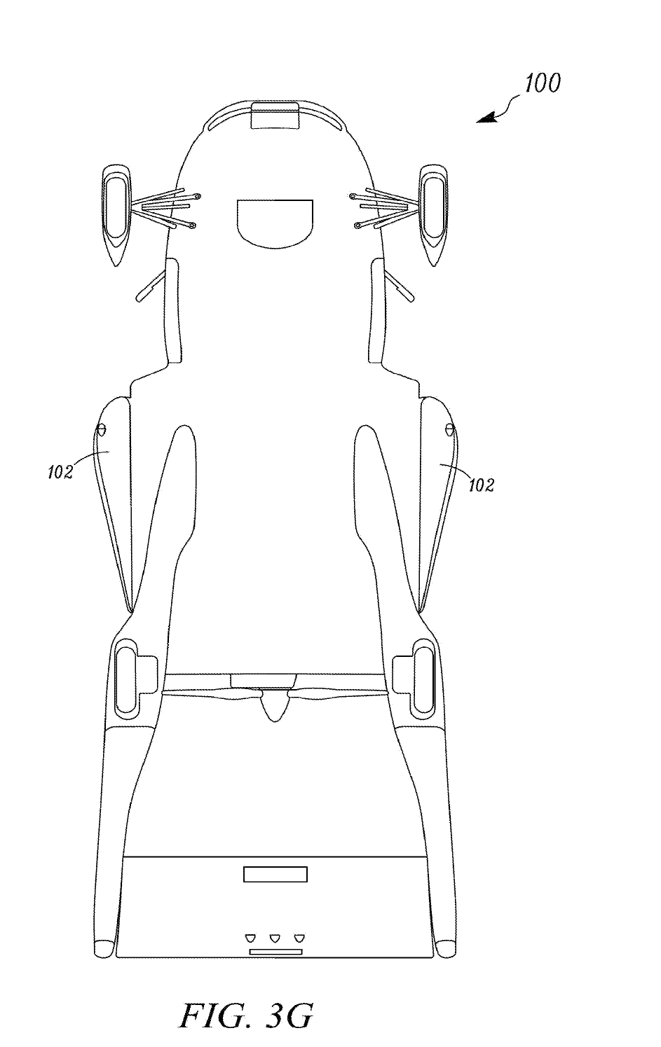

FIG. 3A depicts the roadable aircraft vehicle 100 transitioned to the automotive mode from the flight mode. In the automotive mode, the wings 102 may get fully retracted towards the body 104 of the roadable aircraft vehicle 100. FIGS. 3B-3G show a front view, rear view, left-side view, right side view, top view, and bottom view, respectively, of the roadable aircraft vehicle 100 in the automotive mode

In an exemplary embodiment of the invention, the roadable aircraft vehicle 100 may be designed to fit within a standard construction single car garage, meaning that, in the automotive mode, the vehicle 100 may be less than approximately 20′ long, 8′ wide, and 7′ tall. In addition, to meet Federal Aviation Administration (FAA) Light-Sport Aircraft (LSA) requirements, the vehicle 100 may stall at less than approximately 45 kts (−52 mph) at maximum takeoff weight. To meet LSA requirements, the maximum takeoff weight of the vehicle 100 should be below 1430 pounds.

In various embodiments of the invention, the vehicle 100 may include general automotive features, such as, but not limited to, windscreen washers and wipers, passenger compartment airbags, seat belts, front and/or rear bumpers, tire pressure monitoring elements, ABS/ESC/disk brakes, and/or a crash safety-compliant cockpit (i.e. head padding on dash and beams), helping ensure the vehicle 100 meets all required road safety standards.

Airfoil for Folding Wing Roadable Aircraft Vehicle

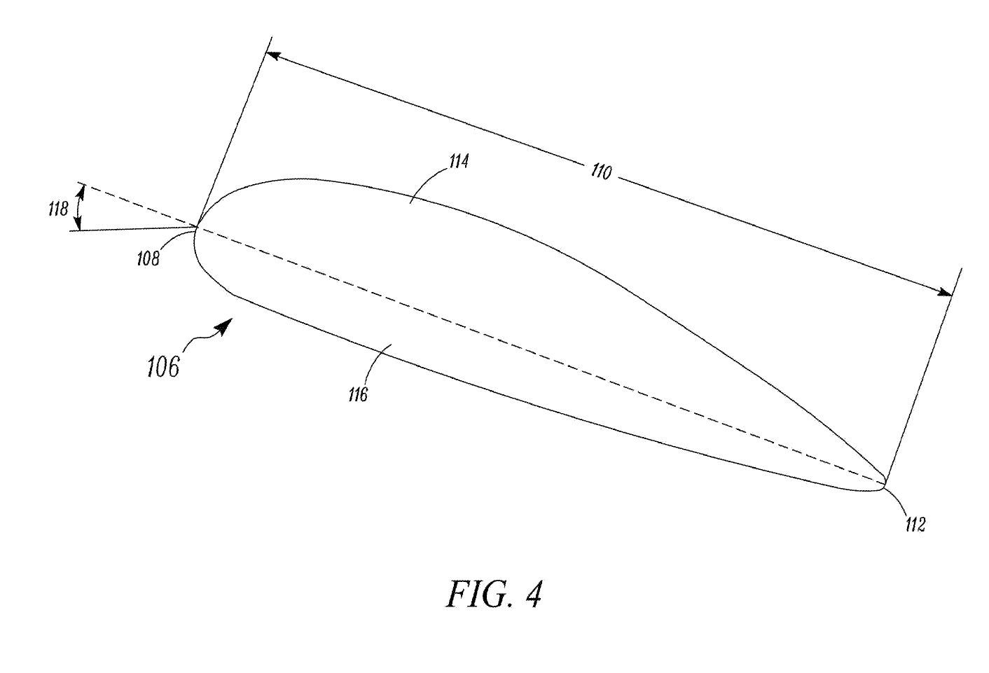

FIG. 4 shows a shape of an airfoil 106 for the folding wing 102 that may be used on the folding wing 102 of the roadable aircraft vehicle 100. As shown in the FIG. 4, the airfoil 106 may include a leading edge 108, a chord length 110, a trailing edge 112, an upper surface/top surface 114, a bottom surface/lower surface 116, and an angle of attack 118. The shape of the airfoil 106 may be used on the folding wings 102 of the roadable aircraft vehicle 100 such that the roadable aircraft vehicle 100 may fit inside the geometric constraints of a single car garage, while also providing access to a cockpit/passenger compartment with the wings 102 folded and meeting the LSA specifications required by the FAA. As shown in the FIG. 4, the exemplary airfoil 106 may include a low moment coefficient magnitude, very high unflapped C_{L max} (maximum lift coefficient), and a flat bottom to facilitate smooth airflow.

In an exemplary embodiment of the invention, the airfoil 106 may be designed and optimized for the unique design constraints of the roadable aircraft vehicle 100, such as the roadable light sport aircraft 100. The design constraints may include: (a) a very high (>approximately 1.95), unflapped maximum lift coefficient driven by the limited wingspan due to the need to fit inside a single car garage with the wings 102 folded up and the need to meet the 45 kt stall speed limitation for light sport aircraft vehicle; (b) a low absolute magnitude of the moment coefficient to keep the tail loads low, which is necessary in order to fit the length of the vehicle 100 in a single car garage; and (c) a substantially flat bottom surface 116 of the airfoil 106 in order to minimize buffeting due to separated airflows when the wing 102 is in the folded position. In one embodiment, a hinge line for the folding wing 102 may be very close to the bottom surface 116 of the airfoil 106. In one embodiment, a higher or lower unflapped maximum lift coefficient may be required.

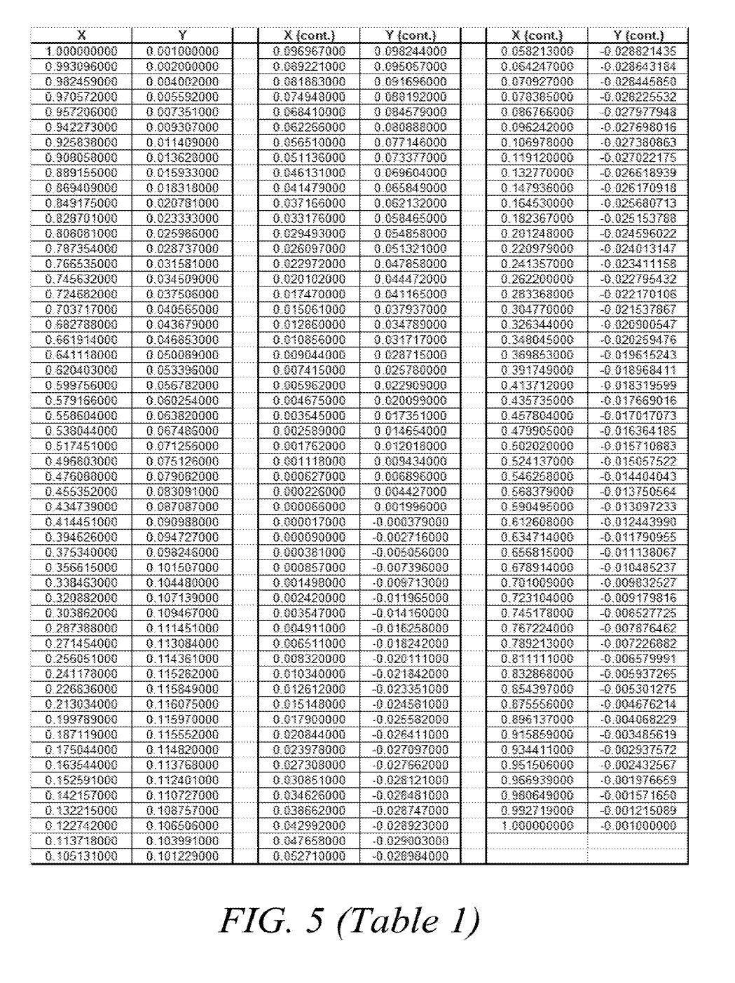

In an embodiment of the invention, example airfoils 106 may be generated through a known airfoil design program, such as, but not limited to, MIT's X-foil airfoil design program, which is an interactive program for the design and analysis of subsonic isolated airfoils. Table 1, as shown in FIG. 5, shows non-dimensional X and Y coordinates for an example profile of the airfoil 106 meeting the above-identified requirements. The coordinates progress from the trailing edge 112, over the top surface 114, around the leading edge 108, down the bottom surface 116, and back to the trailing edge 112 of the airfoil 106. It should be noted that minor deviations to this set of coordinates may be consistent with the profiles of the airfoil 106 described and shown herein. In general, the basic characteristics of this airfoil 106 series may include: (a) a maximum section lift coefficient in excess of approximately 1.95 at Reynolds numbers between 1 and 2 million without extension of any type of flap or lift-enhancing device; (b) an absolute magnitude of the moment coefficient less than approximately 0.045 over the range of angles of attack 118 from 0 to 17 degrees; and (c) the substantially flat bottom surface 116 over at least approximately 50% of the chord length 110 of the airfoil 106 that may enable efficient and compact folding of the wing 102 and minimal aerodynamic buffeting due to flow separation when in the folded position. In one embodiment, a higher or lower maximum section lift coefficient and/or absolute magnitude of the moment coefficient may be required.

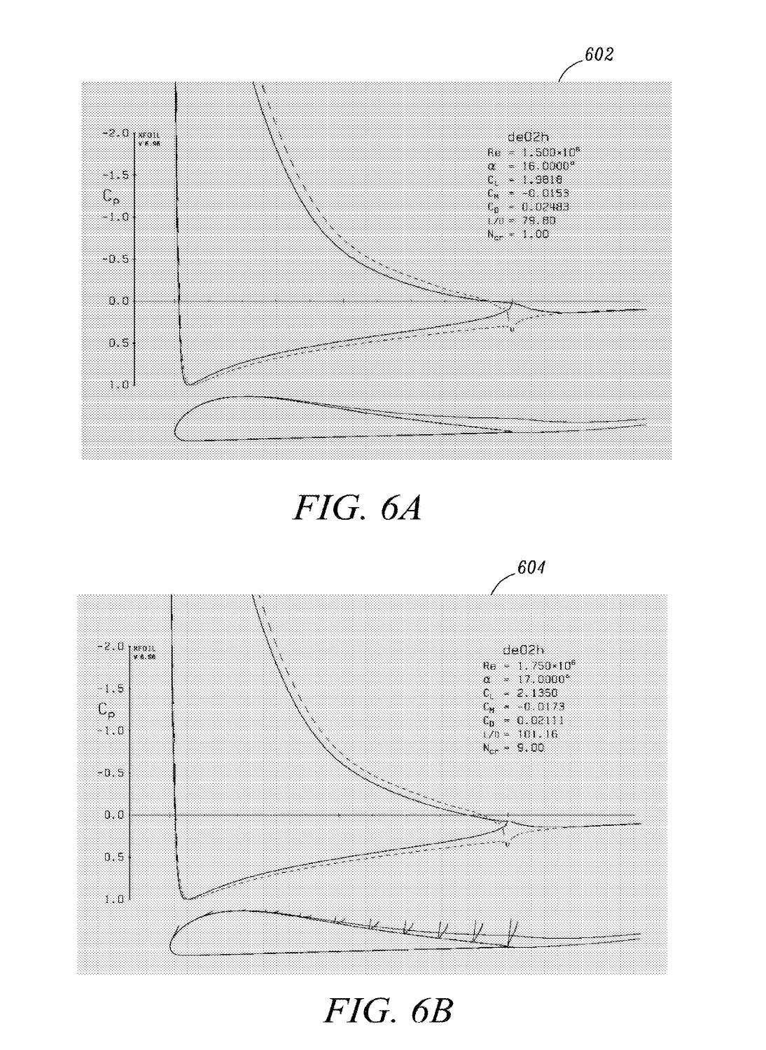

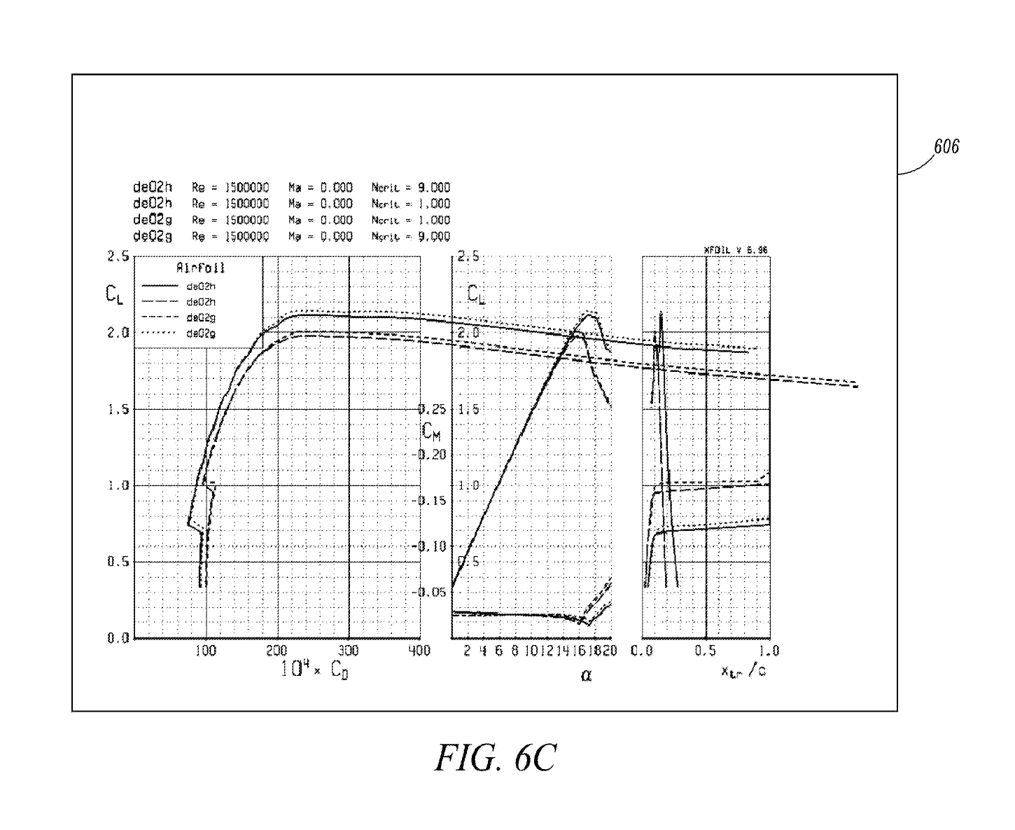

A profile of this airfoil 106 is shown in FIG. 6A, along with a graph 602 of the pressure coefficient over the surface of the airfoil 106 and the boundary layer growth on the airfoil 106 at a 16 degree angle of attack 118, a Reynolds number (Re) of 1,500,000, and a Mach number of zero (incompressible assumption). A conservative exponential for the boundary layer growth model was used (N_{cr}=1.0) in order to simulate the effect of bugs and dirt on the leading edge 108 of the wing 102. As FIG. 6A shows, even with this conservative model, a section C_{L} of 1.98 may be achieved.

When more typical boundary layer growth exponents are used that typify a smooth composite surface (N_{cr}=9.0), section lift coefficients may exceed 2.1 without flap deflection under these non-dimensional parameters that are typical of a stall scenario for a light sport general aviation aircraft, such as the roadable aircraft vehicle 100. A graph 604 showing the pressure coefficient over the surface of the airfoil 106 and the boundary layer growth on the airfoil 106 at a 17 degree angle of attack 118 with a Reynolds number of 1,750,000 is shown in FIG. 6B. Such shapes of the airfoil 106 may be very useful for a folding wing 102 LSA and/or the roadable aircraft vehicle 100.

In one embodiment, a smaller wing area may be important in minimizing the folded dimensions of the vehicle 100. However, regardless of a size of the wing 102, the vehicle 100 may meet the 45 kt stall speed requirement, which drives a high C_{L max}. The required C_{L max} may be achieved by designing the airfoil 106 with the location of maximum camber farther forward than is found in most state of the art airfoils. While airfoils generally focus on maximizing the region of laminar flow—and creating a maximum lift to drag ratio (L/D) at cruise—this may not be necessary for airfoils 106 for the roadable aircraft vehicle 100 as, due to the conditions the vehicle 100 may operate under (e.g., in the automotive mode, with dirt and bug debris build-up on the leading edge 108 of the folded wing 102), extended laminar flow regions may not be easily and repeatably produced on the surface of the airfoil 106 when in the flight mode. The far forward maximum camber and thickness may make the performance of the airfoil 106 less sensitive to dirt and bug buildup, and may allow for a smaller wing area due to the higher section C_{L max}.

In order to minimize the magnitude of the moment coefficient (C_{M}), in one embodiment a top back side (not shown) of the airfoil 106 may have a very slight reflex to it. This may make an area around the trailing edge 112 very thin, which may be undesirable for many state of the art airfoils due to control surface bending loads. In one embodiment, since the moment coefficient must stay low in the roadable aircraft vehicle 100, in order to allow for minimal tail volume (to fit inside the garage), the wing 102 is unflapped, which means that bending moments from control surfaces are not generally an issue. The section may be thin near the trailing edge 112, and thus, reduce the moment coefficient to something that may be managed by a smaller tail volume.

In one embodiment, in order to minimize aerodynamic buffet of panels of the wing 102 when the wing 102 is folded, and to provide for a simple hinge arrangement with minimal aerodynamic impact, the bottom surface 116 of the airfoil 106 may be substantially flat. This may include the airfoil 106 having a flat, or substantially flat portion extending over at least 50% of the chord length 110 of the airfoil 106, or more. In an alternative embodiment, the substantially flat portion on the bottom surface 116 surface may extend over less than 50% of the chord length 110 of the airfoil 106. In addition to reducing wing buffet when the wings 102 are folded, the substantially flat bottom surface 116 sections of the airfoil 106 are easy to build on a flat table, thereby reducing manufacturing costs.

FIG. 6C shows a graph 606 of typical airfoil polars for an example airfoil 106 at typical stall Reynolds numbers with dirty and clean boundary layer growth. The absolute magnitude of the moment coefficient remains well below 0.04 throughout all normal angles of attack 118 (until very deep stall). This low moment coefficient helps maintain a lower downforce requirement from the tail during trimmed flight while still allowing the leading edge 108 of the wing 102 to be aft of the door of the vehicle 100 (helping ease entry and exit).

Folding Wing Mechanism

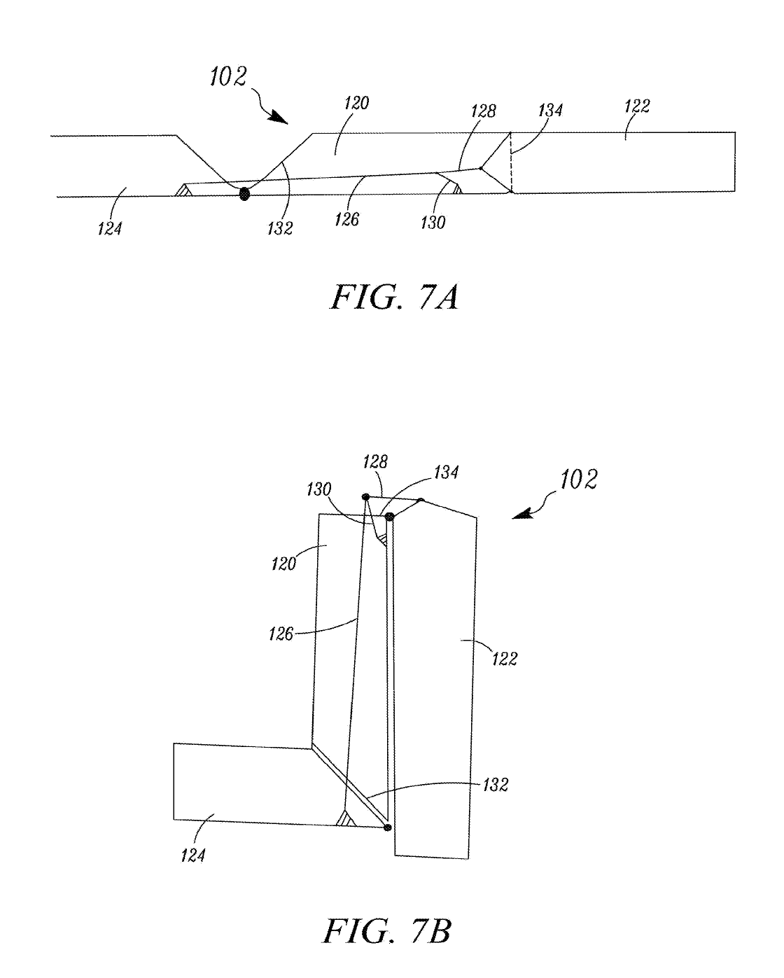

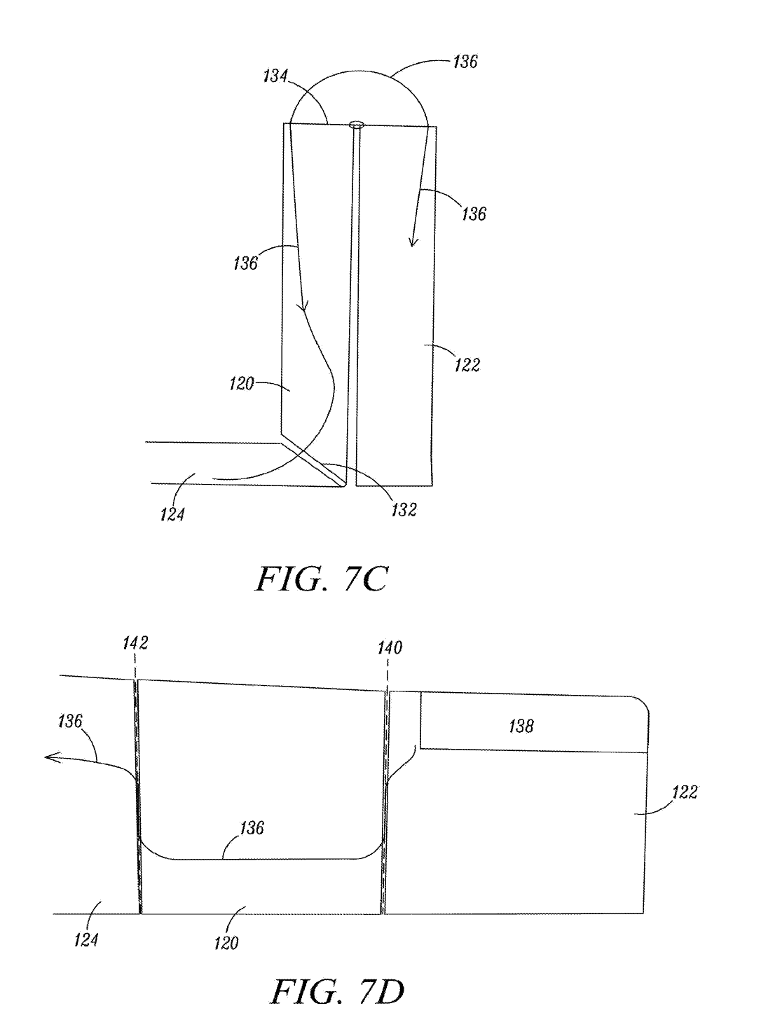

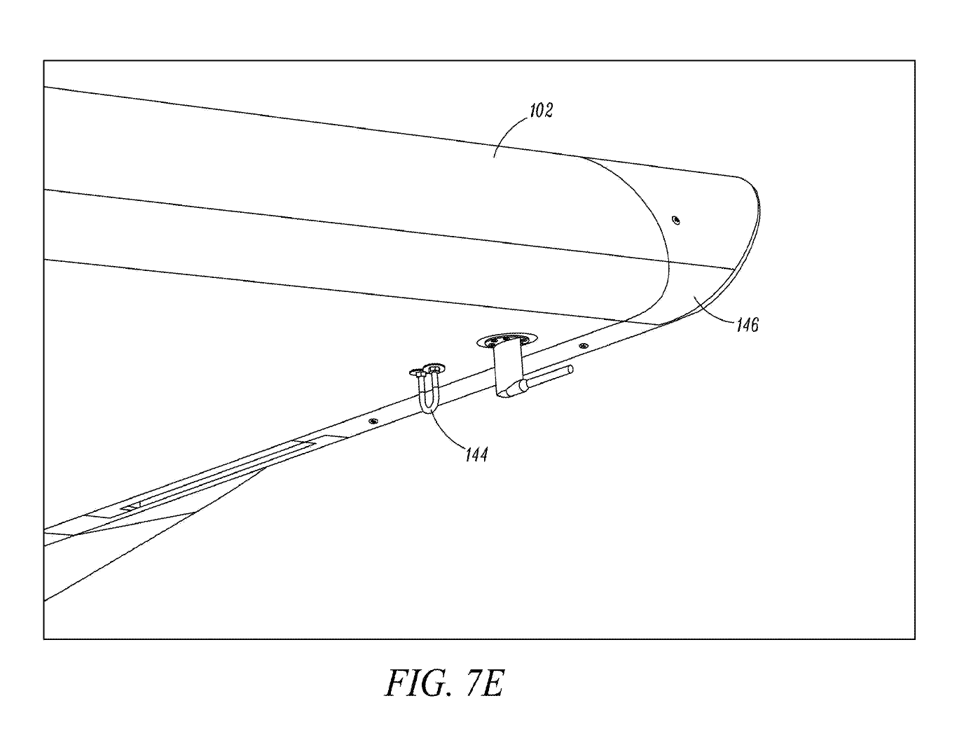

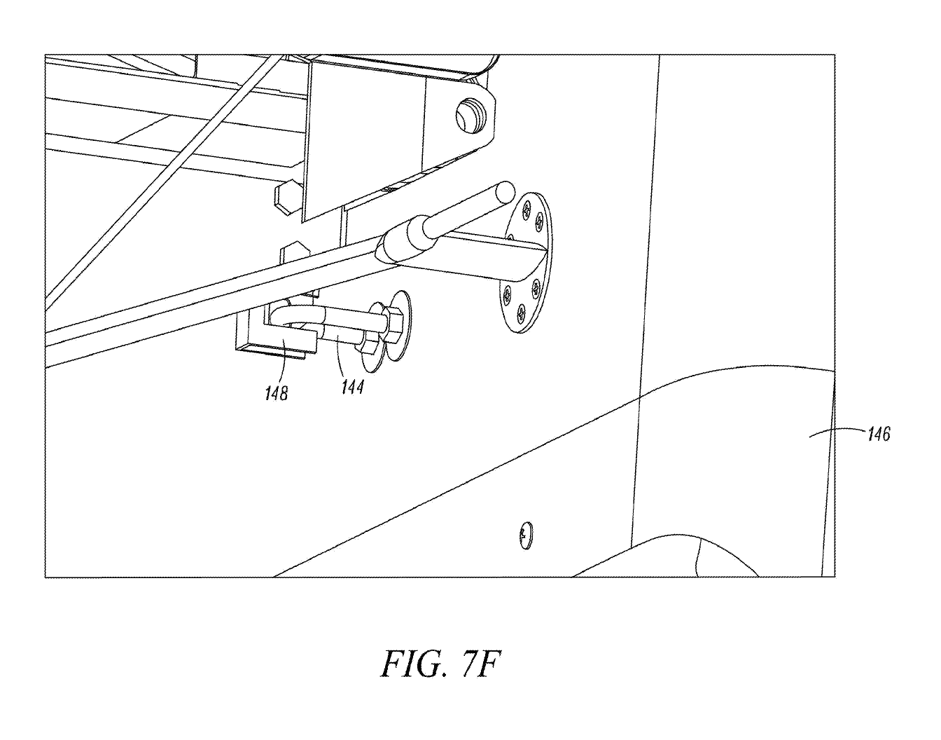

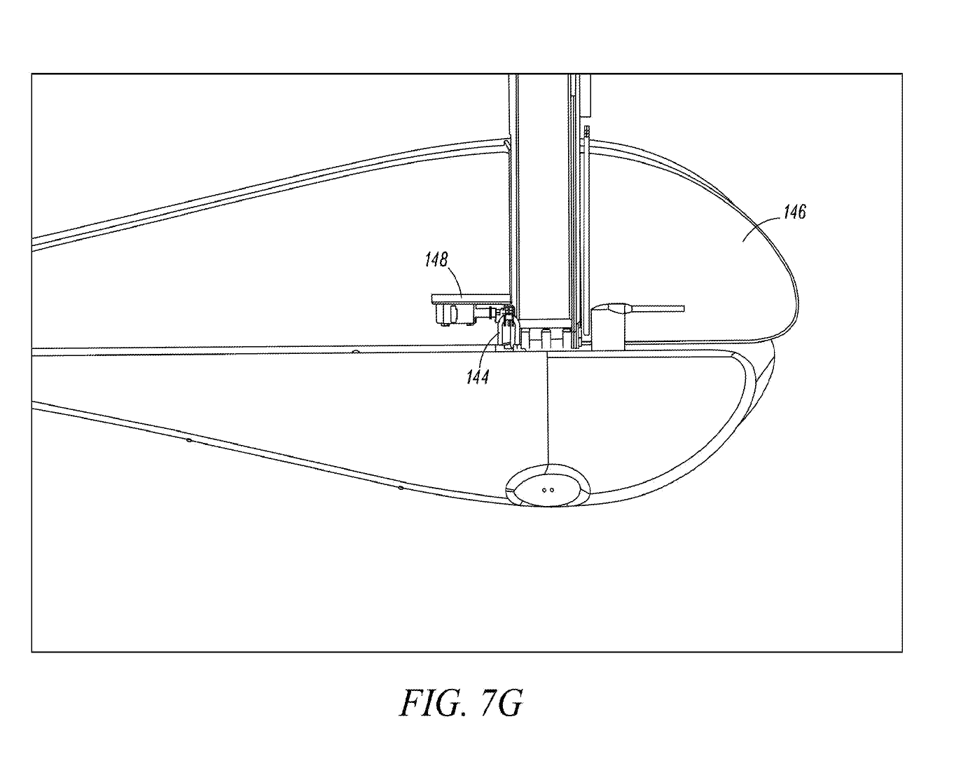

FIG. 7A shows a top view of the folding wing 102 in the extended/deployed position, according to an embodiment of the invention. As shown in the FIG. 7A, an example folding wing 102 may include two separate folding sections, a root folding section 120 (or an inner section 120 or an inner wing 120) and an outer folding section 122 (or an outer section 122 or an outer wing 122), with coordinated folding and unfolding mechanisms, such as a push-pull rod linking the sections. The folding/unfolding mechanism may cause a segment of the outer wing 122 to fold and unfold when a segment of the inner wing 120 folds and unfolds. A coordinated system may allow the wing 102 to fold and unfold with only one actuator, thus saving weight, complexity and increasing reliability. One embodiment of the invention may include the use of steel cables and pulleys in the folding/unfolding mechanism. However, differential thermal expansion between the cables and the carbon fiber wing may cause the position of the outer wing 122 with respect to the inner wing 120 to vary with temperature, while long cable runs create springiness in the mechanism that may cause the outer wing to bounce relative to the inner wing 120.

To avoid the possible problems from using a cable and pulley system for folding and unfolding the wing 102, one embodiment of the invention may include a wing folding mechanism using push-pull rods instead of cables and pulleys. By utilizing materials with the same thermal expansion coefficient as the wing 102, any variation with temperature may be avoided. Also, by using push-pull rods with high stiffness, any significant springiness in the system may be removed. The resulting mechanism may positively actuate the section of the outer wing 122 relative to the section of the inner wing 120 when the section of the inner wing 120 is folded relative to the vehicle 100. Folding mechanisms using push-pull rods may also provide more precise positioning of the outer wing 122 with respect to the inner wing 120 while providing a more mechanically simple system.

In one embodiment, the folding system may include a fixed main spar 124 and two or more wing panels: the inner wing 120 and the outer wing 122. In an alternative embodiment, the system may be repeated for multiple panels. The system may include three links: a main link 126, a secondary link 128, and a lift link 130. The main link 126 is connected on one end to a fixed (but adjustable) location on the main spar 124, and on the other end to the other two remaining linkages 128, 130. The secondary link 128 is connected to the outer wing 122, and the above mentioned connection with the main linkage 126 and the lift linkage 130. The lift linkage 130 is connected to the inner wing 120, and the above mentioned connection with the main linkage 126 and the secondary linkage 128. In an exemplary embodiment of the invention, the inner section or the inner wing 120 may extend from a fuselage of the vehicle 100. Specifically, the inner wing 120 may include a root end 132 pivotably couplable to the fuselage through the main link 126 (i.e., via the first pivoting mechanism). The inner wing 120 may also include a distal end 134 through which the outer section or the outer wing 122 is pivotably connected by means of the secondary linkage 128 (i.e., via the second pivoting mechanism).

FIG. 7B shows a side view of the folding wing 102 in the retracted (or folded) position, according to an embodiment of the invention. Since the main linkage 126 is fixed to the spar 124, motion of the inner wing 120 with respect to the main spar 124 (folding) may cause relative motion between the inner wing 120 and the main linkage 126. This folding motion may provide the necessary motion to drive what is essentially a 4-bar linkage that may include the inner wing 120, the outer wing 122, the secondary linkage 128 (second pivoting mechanism), and the lift linkage 130 (first pivoting mechanism). When the inner wing 120 is folded, the 4-bar linkage may drive the outer wing 122 into a folded position, and vice-versa. By modifying the lengths of the various linkages 126, 128, 130, and their mount locations, the relative motions of the wing sections 120, 122 may be adjusted. For example, it may be advantageous to have a tip of the outer wing 122 remain high and not approach the ground as the wing 102 folds.

In one embodiment, the 4-bar linkage may be used to maintain the wing position unfolded in the flight mode and folded in the automotive mode. Secondary locks may also be used to increase reliability, but properly sized linkages 126, 128, 130 could suffice as a primary means of positioning the wing 102 for all aspects of flight.

In one embodiment, the wing folding mechanism may include a covering element (not shown) located at or near the root end 132 of the wing 102. This covering element may be used to cover any open sections between the wing 102 and the body 104 of the vehicle 100 when the wing 102 is folded, thereby preventing water and/or road debris from entering the body 104 of the vehicle 100 through the open root section. The covering element may include a stationary cover or a pivotable covering portion that pivots out to cover the first pivoting mechanism (e.g., lift linkage 130) upon folding of the wing 102. In one embodiment, the covering portion may include a flexible sheet attached to the wing 102 and the body 104 to cover the first pivoting mechanism when the wing 102 is both deployed and folded.

In one embodiment, the folding wing 102 may have one or more measurement devices (e.g., a Pitot tube) (not shown) extending from the lower surface 116 thereof. This measurement device may be covered when the wing 102 is folded, for example by placing a cavity (not shown) on the lower surface 116 of the wing 102 that conformingly encloses the measurement device therein upon folding of the wing 102 into the stowed (folded) configuration. For example, in one embodiment, a Pitot tube could extend from the lower surface 116 of the inner wing section 120, with a cavity placed in a corresponding location on the outer wing section 122 so that, when the wing 102 is folded, the Pitot tube sits within the cavity, thereby allowing the wing 102 to be folded up until the lower surfaces 116 of the inner and outer sections 120, 122 abut without damaging the Pitot tube. Alternatively, the measurement device may be placed on the lower surface 116 of the outer wing section 122, with the cavity in the inner wing section 120. In one embodiment, the cavity may have at least one covering element adapted to substantially cover the cavity when the wing 102 is deployed. This covering element may include a number of bristles, a flexible sheet, and/or a solid door element (e.g., a pivoting, spring-loaded hatch). In an alternative embodiment, the measurement device may be adapted to pivot or retract into the covering element located at the root end 132 of the measurement device when the wing 102 folds.

In one embodiment, the folding wing mechanism may be coupled to an electronic control system that includes a series of stored logic commands for controlling the deployment and retraction of the wing(s) 102. The stored logic commands may include a set of instructions for folding and unfolding and/or a number of safety interlocks for the wing 102 that must be met before any deployment or retraction of the wing 102 may commence.

Wing Control Surface Actuation

FIGS. 7C and 7D show a side view and a top view, respectively, of the folding wing 102 with a push pull cable 136 (herein after interchangeably referred to as cable(s) 136) in a retracted position and deployed position respectively, according to an embodiment of the invention. In an exemplary embodiment of the invention, the wings 102 on aircraft typically contain control surfaces 138. These control surfaces 138 may include but are not limited to: ailerons, flaps, speed brakes, and flaperons. The control surfaces 138 are depicted as ailerons in FIGS. 7C and 7D. These surfaces 138 are typically controlled with cables (in a pull/pull configuration or a push/pull configuration), push rods, torque tubes, or an actuator. For smaller aircraft, actuators may not typically be used due to their weight and complexity. Providing control surface actuation through the folding wing 102 may create additional challenges. This is due to the fact that the means of actuation must bend as the wing 102 bends, which may produce fatigue and buckling of the actuation means over time. Also, it is highly desirable to not have the control surface 138 disconnect from the rest of the vehicle 100 when the wings 102 fold up as it reduces reliability and adds complexity and weight.

In one embodiment, torque rods may be used to actuate the ailerons 138. These torque rods may, for example, utilize universal joints and offset hinges to allow the torque rods to be folded along with the wing 102. However, such torque rods may add unwanted additional weight and complexity to the vehicle 100. As a result, one embodiment of the invention may include the use of a single, light weight, push-pull cable 136 to actuate the control surfaces 138 on the wing 102.

One embodiment of the invention may include the use of push-pull cables 136 manufactured from a material such as, but not limited to, a steel braided or twisted cable in a sheath. However, in embodiments where such materials do not provide adequate stiffness, other materials may be used. For example, in one embodiment, the push-pull cables 136 may be manufactured from cables utilizing a steel ribbon/ball bearing combination, such as those manufactured by VPS Control Systems Inc. of Hoosick, N.Y., USA, under the trade name Flexball®. These cables 136 provide adequate stiffness and strength for use on a control surface 138, but there are restrictions on their use. For example, these cables 136 have a significant minimum bend radius, which may be too large to just string the cable 136 through the wing spars 124 and have it bend when the wings 102 fold. In addition, there must be extra slack in the cable 136 when the wings 102 are unfolded, as the distance the cable 136 must traverse is shorter when the wings 102 are unfolded than when the wings 102 are folded.

One embodiment of the invention may therefore include wing control surface actuators including sections spanning the two wing sections 120, 122 of the folding wing 102 that twist rather than bend upon folding of the wing 102. In this embodiment, as shown in FIGS. 7C and 7D, the cables 136 are positioned at folding sections 120, 122 of the wing 102 such that there is a sufficiently straight section running along the length of the folding sections 120, 122, or a portion thereof, to allow the cable 136 to twist along its axis. In order to hold the cables 136 below the maximum angle of twist per unit length, the cable 136 should extend along a sufficient portion of the folding wing 102 to allow for the required overall twist over the length of the fold portion without exceeding the maximum twist limits of the cable 136. In one embodiment, a twisting motion may be utilized substantially exclusively by running the cable 136 along a hinge line 140, 142 of the wing fold. In an alternative embodiment, it is not necessary for the straight part of the cable 136 to lie completely along the wing hinge axis 140, 142, but instead only the end of the straight section needs to lie on the axis 140, 142 of the wing 102.

Wing Latching and Tie-Down Systems

FIGS. 7E-7F show a wing tip 146 of the deployed and retracted folding wing 102 respectively having a latching element 144, according to an embodiment of the invention. FIG. 7G is a bottom view of the wing tip 146 of the retracted folding wing 102 and latching element 144. One embodiment of the invention may include one or more multi-purpose wing tie-down and latching elements 144. Prior wing folding mechanisms may not provide enough strength to hold the outer wing 122 securely in the folded position, at least because of a large lever arm acting on the folding mechanism for any force applied at the wing tip 146. As a result, prior folding wing mechanisms may generally need to be very strong (generally requiring significant additional weight to be added to the mechanism to provide the necessary strength and rigidity) and/or include separate wing locking mechanisms for securing the outer wing section 122 in the folded position (e.g., through the use of separate tying systems such as ropes). In addition, aircraft typically have separate tie-down points on the tips 146 of their wings 102 for use in anchoring the aircraft on the ground when not in use. These serve two purposes: firstly, they prevent the plane from being blown around in high winds and, secondly, they maybe used to secure the plane by using a chain and lock to secure the plane to the ground. To withstand sufficient loading to provide a safe and secure anchoring system for an aircraft, these tie-down elements are generally very strong.

An example wing locking element 144 may, for example, include bent aluminum pieces on the wing tips 146 that interface with a lock mechanism at the root 132 of the folding wing 102, the locking mechanism being engaged when the wing 102 is in the folded position.

One embodiment of the invention may include the use of a multifunction latching element 144 that may be used to securely lock the wings 102 in place when folded (thereby avoiding the need for additional tying or locking systems) while also providing an anchoring element to allow the aircraft wings 102 to be securely tied-down when extended but not in use.

An example multifunction latching element 144, as shown in FIGS. 7E to 7G, may include one or more tie-down bolts 144, e.g., U-bolts, attached to the wing tip 146 of the folding wing 102. The tie-down bolts 144 act as a tie-down anchoring element for the aircraft vehicle (such as a roadable aircraft vehicle 100 in the flight mode) when not in use. When the wings 102 are folded up, the tie-down bolt 144 in each wing 102 intersects the outer skin of the vehicle 100 under the inner wing 120, with the inner wing 120 being shorter than the outer wing 122. Mounted below the spar 124 is a latch 148, e.g., a car-door style latch. The latch 148 may grab onto the tie-down bolts 144 and securely hold the wing 102 in the folded position. Such a multifunction latching element 144 may provide an efficient solution that provides a dual use latching and anchoring element that may result in significant savings in weight, drag, and complexity.

Optical Wing Marking System

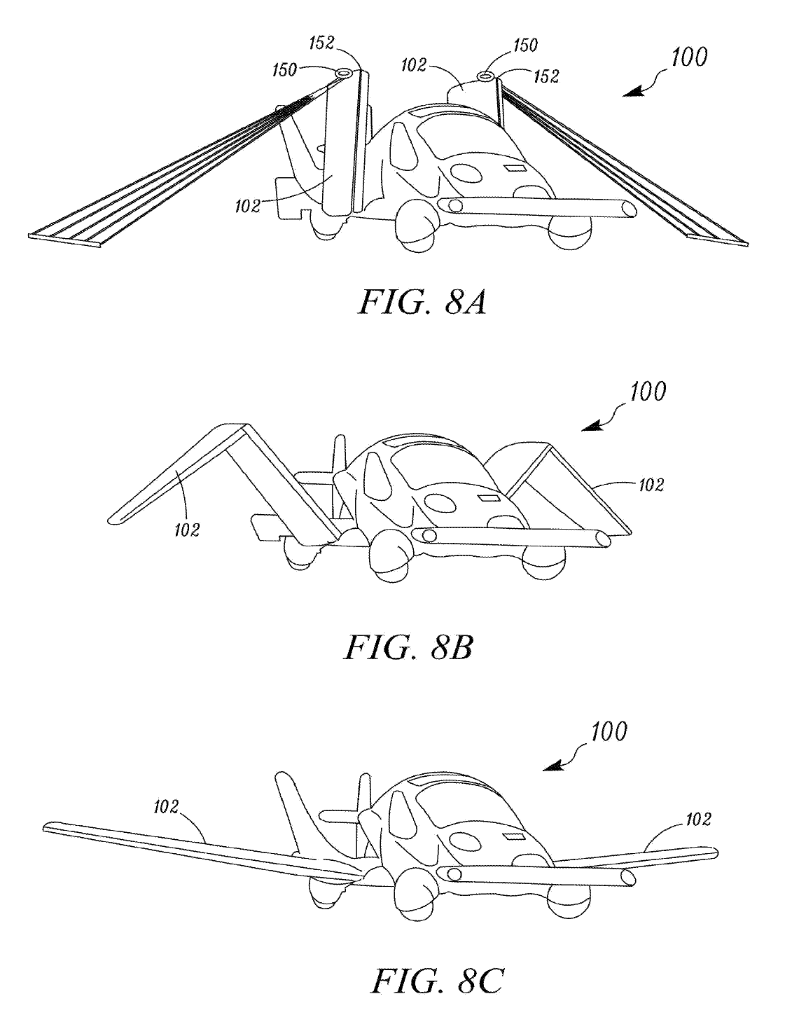

FIG. 8A shows the roadable aircraft vehicle 100 in the automotive mode having an optical wing marking system 150 for the folding wing 102, according to an embodiment of the invention. One embodiment of the invention may include the one or more optical wing marking systems 150 for providing an operator with a visual guide showing the deployed footprint of the folding wings 102 on the roadable aircraft vehicle 100. In prior art folding wing mechanisms, where it is difficult to judge the deployed footprint of the folding wing 102 after deployment without manually measuring the area surrounding the vehicle 100, there is a risk of the unfolding wing 102 hitting something and either damaging the wing 102 or the object that is impacted. As it is difficult to judge how far the wings 102 will extend, it is therefore prudent to ensure that there is sufficient space around the vehicle 100 prior to deploying the folding wings 102 to ensure that they do not contact anything during deployment.

To avoid this issue, one embodiment of the invention, as shown in FIGS. 8A to 8C, may include the optical wing marking system 150 (including, for example, one or more laser lights or other lights) mounted to the vehicle 100. The optical wing marking system 150 is adapted to project an image of the outline of the unfolded wing 102 onto the ground before the wing 102 is unfolded. Thus, the operator may visually confirm whether the area is clear and there is sufficient room to deploy the wings 102. FIG. 8B shows a view of the roadable aircraft vehicle 100 transitioning from the automotive mode to the flight mode, and FIG. 8C shows a view of the roadable aircraft vehicle 100 in the flight mode (fully transitioned from the automotive mode.) The operator may start the transitioning of the vehicle 100 based on the information obtained from the optical wing marking system 150. The laser wing marking systems 150 may, for example, be mounted at a mid-wing fold 152 of the folding wing 102, as shown in FIG. 8A, with the mid-wing hinge section 152 of the wing 102 covering and protecting the laser wing marking system 150 when the wing 102 is unfolded. After confirming that there is sufficient room to deploy the wing 102, the laser wing marking system 150 may be turned off and the wings 102 deployed, as shown in FIGS. 8B and 8C. The optical projector(s) (e.g., lasers) may serve as the optical wing marking system 150, and in various embodiments, may show a line at the location of wingtip 144, a plurality of points indicating the corners of the wing 102, and/or a full outline of the wing 102.

In various embodiments, one or more ultrasonic and/or other proximity detectors (not shown) may be integrated into the wings 102 (e.g., at the wing tips 146) to alert the user of obstacles during deployment and/or to automatically stop the wing 102 from deploying further. These proximity detectors may be used in addition to, or instead of, the optical wing marking system 150.

Integrated Automotive Indicators

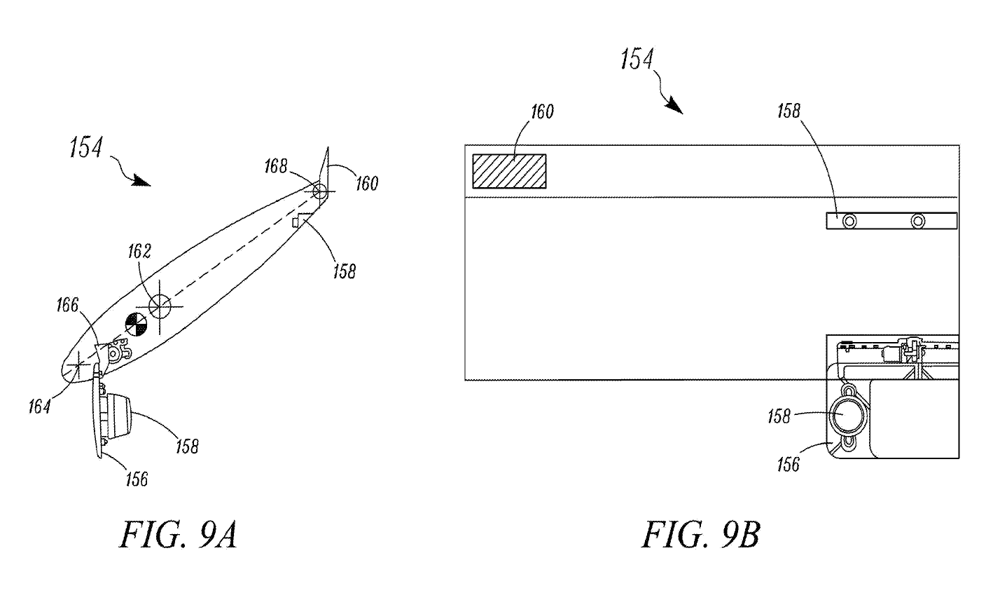

FIGS. 9A and 9B show views of a stabilator 154 of the roadable aircraft vehicle 100 having a folding license plate 156, according to an embodiment of the invention. The stabilator 154 on an aircraft is located at or near the rear of the aircraft and is used as a control surface to control the aircraft in flight. For roadable aircraft vehicles, such as the roadable aircraft vehicle 100 having stabilators 154, depending on the orientation of the stabilator 154 when the vehicle 100 is in the automotive mode, it may produce lift in the rear of the vehicle 100 that may lead to a loss of control of the vehicle 100 if the tires unweight and lose traction. As a result, in order to avoid this problem, one embodiment of the invention may include a control system for holding the stabilator 154 at a negative angle of attack during the automotive mode operation, the negative angle of attack 118 sufficient to at least avoid generating a positive lift and, in some embodiments, sufficient to produce a downforce (similar to that produced by a rear spoiler in an automobile) to increase controllability of the vehicle 100.

One embodiment of the invention may include the roadable aircraft vehicle 100 having the stabilator 154 with one or more integrated automotive elements. For the roadable aircraft vehicle 100, automotive systems such as lights 158 and license plates 156 may increase drag significantly in the flight mode if they are left in position due, for example, to their blunt trailing surfaces. This may significantly reduce the aerodynamic efficiency of the vehicle 100 during the flight mode. In addition, the additional weight from the positioning of automotive systems at the rear of the roadable aircraft vehicle 100 may significantly affect the center of gravity (CG) of the vehicle 100, which could also significantly reduce the aerodynamic efficiency of the vehicle 100 when in the flight mode. While the effect on the center of gravity of the vehicle 100 may be counteracted by adding counterbalancing weight at the front of the vehicle 100, this has the effect of increasing the overall weight of the vehicle 100 itself, which may further reduce the aerodynamic efficiency of the vehicle 100 when in the flight mode.

By incorporating automotive systems into the stabilator 154 of the roadable aircraft vehicle 100, and adjustably stowing the automotive systems when in the flight mode to reduce drag effects, the aerodynamic efficiency of the roadable aircraft vehicle 100 when in the flight mode may be greatly improved while still providing the necessary automotive systems needed for driving the vehicle 100 on public roads. In one embodiment, when in the flight mode the stabilator 154 is fully blown, or located behind the propeller so that the prop-wash increases the air velocity over the surface, thereby increasing its control authority.

Example automotive systems and indication elements that may be incorporated into the stabilator 154 positioned at or near a rear of the roadable aircraft vehicle 100 may include, for example, license plates 156, one or more reflectors 160, and/or one or more automotive lights 158. In the exemplary stabilator 154 with integrated automotive elements shown in FIGS. 9A and 9B, the license plate 156 may fold down out of a bottom section of the stabilator 154, so that the license plate 156 is displayed at the correct angle during the automotive mode, but is stowed flush with the bottom of the stabilator 154 during the flight mode. In an alternative embodiment, the license plate 156 may fold down below the surface of the stabilator 154, with a separate covering element removably extending over the license plate 156 to provide a flush surface on the stabilator 154 and to protect the license plate 156 during the flight mode. A stabilator pivot 162 around which the license plate 156 and the lights 158 may fold down is shown in FIG. 9A.

In one embodiment, the lights 158 of the license plate 156 and/or backup/reverse lights 158 are stowed in the folding mechanism of the stabilator 154. A motor/actuation mechanism 166 for the folding of the license plate 156 may be located at or near the front of the stabilator 154, for example for stabilators 154 having counterweighting position 164 at the front to keep them balanced in order to reduce control forces and prevent flutter. Positioning the motor/actuator 166 in the counterweight position 164 reduces the amount of counterweight needed in the front of the stabilator 154 which, in turn, reduces the amount of counterweight needed at the front of the vehicle 100, thus significantly reducing the overall weight of the vehicle 100.

In one embodiment, an anti-servo tab 168 on an end of the stabilator 154 may rise to a vertical position when the stabilator 154 is in its full up position during the automotive mode, thereby providing a location for the flush mounted reflectors 160 and the lights 158 so that they point backwards at the correct angle with respect to the ground. The lights 158 may also be flush mounted inside the main body of the stabilator 154, but they may need to be angled with respect to the bottom of the stabilator 154 to be viewed at the required angle.

By integrating the license plate 156 and the lights 158 with the aerodynamic surfaces of the stabilator 154, drag is reduced in the flight mode compared to vehicles having the license plate 156 and the lights 158 mounted on fixed surfaces with blunt trailing edges. In addition, the need for clear aerodynamic covers, which may affect the optical properties of the lights 158 and the reflectors 160, and which may not even be allowed for the license plates 156, is eliminated.

Combined Head Lights/Landing Lights

In one embodiment, headlights (for the automotive mode) and landing lights (for the flight mode) may be combined, either by having a separately aimed beam within the same reflector 160, similar to a dual filament headlight with a high/low beam, and/or by mechanically rotating the headlight assembly to point down to orient it as a landing light. The same switch may be used to activate the headlights or landing lights based on the mode of the vehicle 100. As a result, the same lighting system may be utilized for both the automotive and the flight modes in the roadable aircraft vehicle 100, thereby reducing the weight and complexity of the vehicle 100. In one embodiment, top outside marker lights (of the optical wing marking system 150) are mounted in the mid-wing hinge area 152, so that they extend above the wing 102 in the folded configuration, and are folded inside the wing structure when the wing 102 is extended.

Retracting Mirror

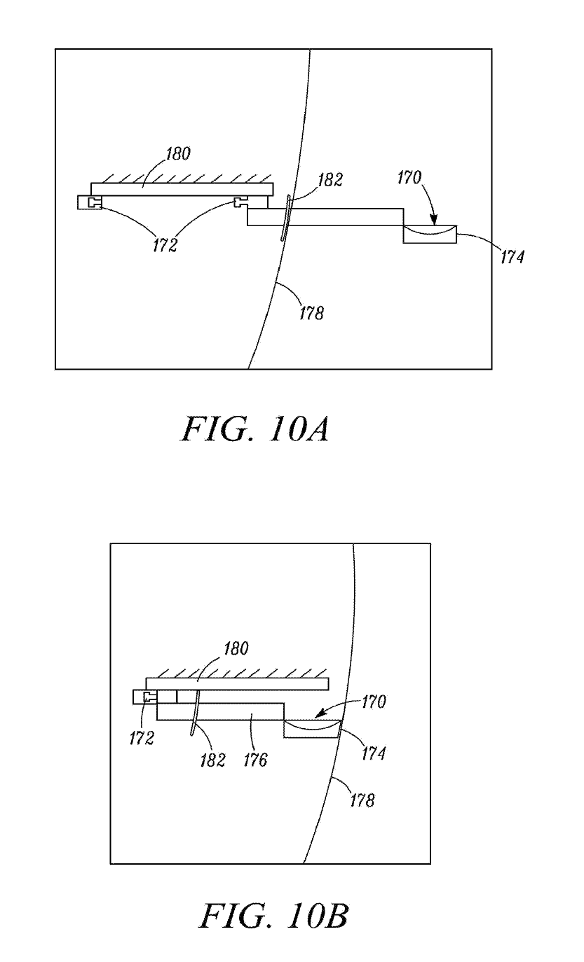

FIGS. 10A and 10B show top views of a retracting mirror 170 (herein after interchangeably referred to as side mirrors 170, rear view mirrors 170 or mirrors 170) in a deployed position and in a retracted position, respectively, for the roadable aircraft vehicle 100, according to an embodiment of the invention. One embodiment of the invention may include a system for controlling adjustably the positioning of the exterior side mirrors 170 for the roadable aircraft vehicle 100, thereby allowing the mirrors 170 to function as the rear view mirrors 170 when the vehicle 100 is in the automotive mode, while allowing the mirrors 170 to be stowed during the flight mode.

In general, cars or multipurpose passenger vehicles are required to have exterior side mirrors that provide a view to the rear of the vehicle during driving operation. In certain embodiments, such as in certain roadable aircraft vehicles 100 where the vehicle 100 is wider than the cabin, such mirrors 170 may need to extend out a significant distance from the passenger compartment to allow for sufficient rear viewing around the body 104 of the vehicle 100. However, such rear view mirrors 170 may cause significant undesirable drag on the roadable aircraft vehicle 100 during the flight mode. As a result, providing the roadable aircraft vehicle 100 with the stowable mirrors 170, that may be deployed during the automotive mode but retracted during the flight mode to reduce drag, may provide significant advantages over fixed position mirrors that cannot be stowed for the flight mode.

The example retractable mirror 170 for the vehicle, such as the roadable aircraft vehicle 100, is shown in FIGS. 10A and 10B. In this embodiment, the mirrors 170 may be telescoped out from the body 104 during the automotive mode, and be telescopingly retracted into the body 104 of the vehicle 100 for the flight mode, for example so that they are conformal with the surface of the vehicle 100 to minimize drag during the flight mode. In one embodiment, a constant force, or other spring, biases the mirrors 170 out, with latches or other locking mechanisms 172 holding the mirrors 170 in the retracted position during the flight mode. When the vehicle 100 is switched to the automotive mode these latches 172 may be released, thereby allowing the mirrors 170 to pop out to the extended positions.

The mirrors 170 may be designed such that an outer edge 174 is positioned flush with the outer surface 178 of the vehicle 100 when retracted. Alternatively, the mirrors 170 may be retracted completely within the vehicle 100, with a covering element, such as, but not limited to, a spring loaded covering door, extending over the mirrors 170 when the mirrors 170 are retracted to provide a flush surface at a wall 178 of the vehicle 100. A covering element 182 may run over a slide rail 180 provided in the body 104 of the vehicle 100. Both the covering element 182 and the slide rail 180 may include the latching arrangement 172 to hold the mirror 170 in place in the retracted position. In a further alternative embodiment, the mirrors 170 may be retracted only partially into the body 104 of the vehicle 100, with an aerodynamically efficient outer edge extending beyond the surface of the vehicle 100 in the flight mode. In a further alternative embodiment, the mirrors 170 may pivotably extend out from the body 104 of the vehicle 100 when in the automotive mode, and pivot down flush, or substantially flush, with the surface of the body 104 of the vehicle 100 when in the flight mode.

In one embodiment, dampers are provided to slow the mirrors 170 at the end of travel. To switch to the flying mode, the pilot may manually press the mirrors 170 into the vehicle 100 until they are flush with the skin and the latch 172 engages. In one embodiment, a push-to-release latching system 172 may be used to deploy and/or release the mirrors 170 upon actuation by an operator. In an alternative embodiment, a powered retracting mechanism may be utilized to automatically retract the mirrors 170 when engaging the flight mode for the roadable aircraft vehicle 100. This powered retraction may be automatically engaged by a control system for converting the roadable aircraft vehicle 100 from the automotive mode to the flight mode (with, for example, the retraction of the mirrors 170 being timed to correspond with the unfolding of the roadable aircraft vehicle wing 102 and/or the switching of the drive system to the flight mode), or be engaged by a separate control mechanism controlled by an operator within the vehicle 100 (e.g., from a control switch, or other control interface mechanism, in the dashboard 200 of the vehicle 100 or at the mirror 170).

Wheel Monitoring Systems

One embodiment of the invention may include a system for controlling non-retracting wheels of the roadable aircraft vehicle 100 when in the flight mode. When an aircraft with non-retracted wheels is flying, the wheels may windmill in the air. This may be problematic for the roadable aircraft vehicle 100 where certain automotive systems that are based on measuring wheel rotation, such as the odometer, and tire pressure monitoring systems, and electronic stability control, may take erroneous readings due to the free-spinning of the wheels when the vehicle 100 is in the flight mode.

To avoid problems associated with the free-spinning of wheels of the roadable aircraft vehicle 100 during the flight mode, various embodiments of the invention may include a system and method for disconnecting the vehicle's odometer from the wheels during flight, and/or feed the odometer with information from another source so that it may, for example, accurately measure miles flown. Alternate sources of distance information could be obtained, for example, from GPS or integrated airspeed measurement systems.

In one embodiment, the wheels may be locked during the flight mode to prevent spinning. For example, one embodiment of the invention may include systems adapted to provide enough friction in wheel bearings to prevent unwanted spinning during flight. Alternatively, or in addition, brakes, or another system, may be automatically activated when the vehicle 100 is airborne to keep the wheels from turning freely in the airstream at flight speed. Another embodiment of the invention may include a covering system adapted to cover enough of the wheel to minimize the exposed wheel area, thereby minimizing drag from the exposed part of the tire and thereby reducing unwanted rotation.

One embodiment of the invention may include a system that measures the actual tire pressure in the roadable aircraft vehicle tire, as opposed to observing the differential rotation of the various tires, to deduce the tire diameter and thus the tire pressure. Such tire pressure monitoring systems, which are unrelated to the spinning of the tires, will therefore be unaffected by any unwanted tire spinning during flight.

Energy Absorbing Crash Structures

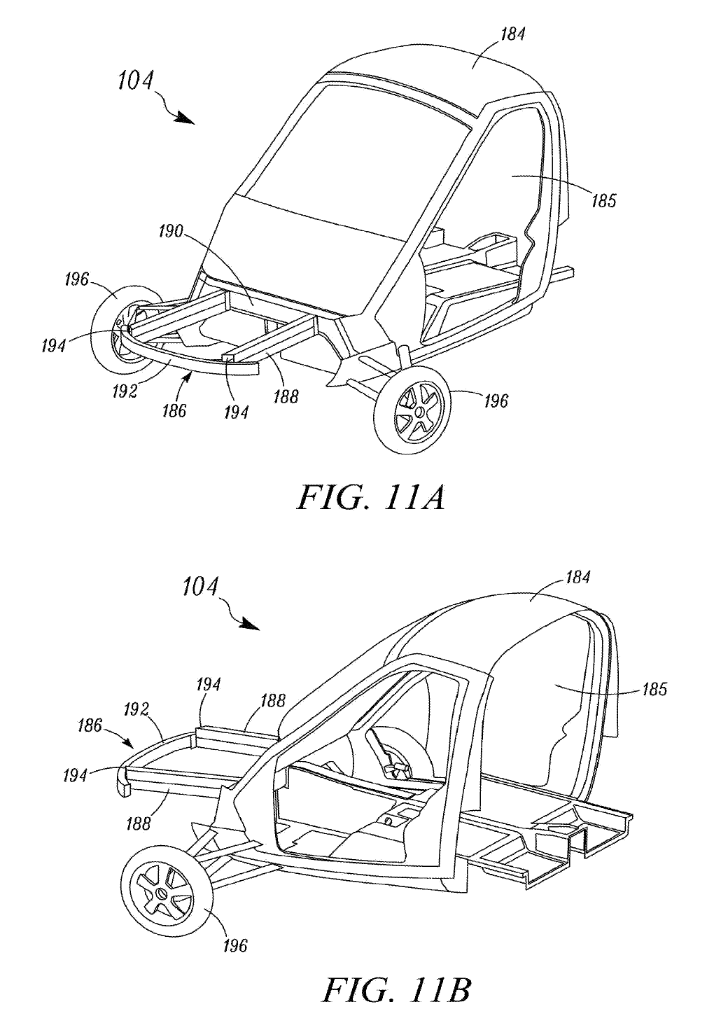

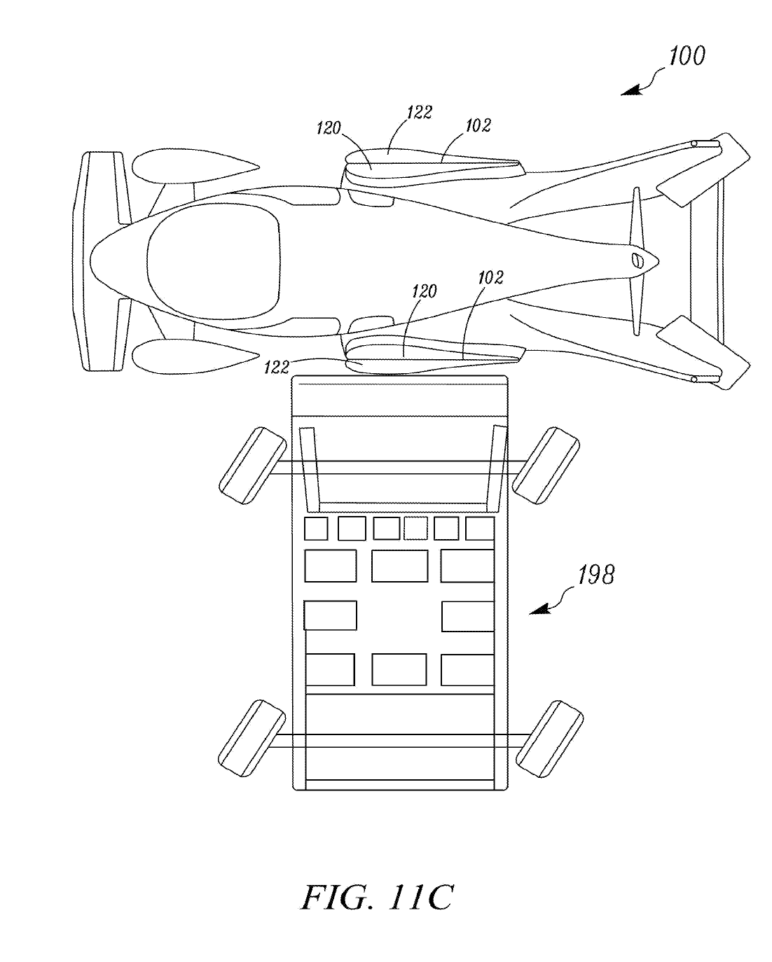

FIGS. 11A and 11B show a crushable front impact energy absorber for the roadable aircraft vehicle 100, according to an embodiment of the invention. In the roadable aircraft vehicle 100, it may be desirable to have one or more energy absorbing zones outside of a frame 184 that includes the rigid passenger compartment 185 to provide protection for passengers during a crash. Energy absorbers absorb energy by deforming in a predictable manner over a set distance, with the kinetic energy of the vehicle 100 being converted into work and heat by deforming material. In the event of a crash, the vehicle 100 is slowed to a stop at a steady rate, reducing peak accelerations on the occupants, while the rigid crash cage (passenger compartment 185) may prevent the occupants from being crushed during the crash.

In order to provide sufficient protection for passengers in the passenger compartment 185 of the vehicle 100, the possibility of front, side, and/or rear impacts should be addressed. For the roadable aircraft vehicle 100, the placement and structural characteristics of energy absorbing zones must also take into account additional issues such as, but not limited to, weight minimization, compatibility with the aerodynamic and structural requirements of the vehicle 100 in both the automotive mode and the flight mode, and the placement of flight control structures such as, but not limited to, the folding wings 102.

One embodiment of the invention may include a forward crumple zone 186 or a front crush structure 186, as shown in FIGS. 11A and 11B. The forward crumple zone 186 may include two elongate rails 188 (herein after interchangeably referred to as rails 188), each having two square sections, one on top of the other. The rails 188 may be formed from materials such as, but not limited to, a metal (e.g., aluminum), a plastic, a composite material, and/or combinations thereof. The two rails 188 may, for example, be placed as far apart as possible in a front hood area 190 of the body 104 of the vehicle 100. A bumper 192 or a hollow substantially rigid cross member 192 may then be mounted to a front distal end 194 of each of the two rails 188. For the roadable aircraft vehicle 100 having wheels 196 located outboard of the body 104, the rails 188 are closer together than in a conventional car.

For the roadable aircraft vehicle 100 having an engine placed in the rear of the vehicle 100, the rear placement of the engine may allow the rails 188 to work in a relatively empty space, without large incompressible objects such as the engine to alter the crash deceleration pulse. The rails 188 may be fastened to one or more large, hollow composite beams running transversely across the vehicle 100 and, for example, just in front of the passenger compartment 185. This rigid cross member 192 may transfer the crash loads from the rails 188 to pillars and rocker beams and center console, and from there to the rest of the vehicle 100. The cross member 192 may be reinforced behind the rails 188 with longitudinal ribs to distribute the forces to the beam skins. A doubler and cross web supporting the rails 188 may be used to keep them in place during an angled impact.

FIG. 11C shows a top view of the roadable aircraft vehicle 100 undergoing a side impact collision, according to an embodiment of the invention. For side impact, as shown in FIG. 11C, the folding wings 102 of the roadable aircraft vehicle 100, which are folded up against the sides of the vehicle 100 when in the automotive mode, may be used to provide side impact protection, as a side-impacting vehicle 198 or other object 198 will hit the folded wings 102 before hitting a door of the vehicle 100. Since the folding wings 102 have substantial depth in that axis, there is room available within the interior of the wings 102 to place an energy absorbing structure and/or material, such as, but not limited to a crushable panel, a block of honeycomb, and/or other energy absorbing structures or materials, within the wing 102 to provide energy absorbing side-impact protection for the passenger compartment 185. The energy absorbing structures/materials placed in the wing 102 may also be used to provide structural strength to the wing 102 itself during flight by, for example, acting as wing ribs or other structural strengtheners. This energy absorber may also serve as a mounting point for a rub strip on the exterior surface of the outer wing 122 panel to protect against door dings, shopping cart hits, and other small scale impacts. The wing panels 120, 122 may be removable to allow for easy replacement if damaged in an impact.

Side impact protection may also be provided by one or more reinforced composite door beams, constructed, for example, from hollow or foam filled composites that connect the door latch with the front top door hinge to form the backbone of the door structure. This, along with a higher than normal rocker beam positioned at bumper level, will take impact loads from outside, and the door beam will help keep the passenger from being ejected from the vehicle 100. The rest of the door may be formed from a lightweight skin to save weight. In one embodiment, the lower hinge serves only to guide the door during use, not as a crash element. The inside structure of the vehicle 100, such as the raised part of a tub that a seat is mounted to, may also provide energy absorbing capabilities.

Rear impact protection in a vehicle such as, but not limited to, the roadable aircraft vehicle 100 may be provided by tail booms and/or tail structures of the vehicle 100 being used as a collapsible energy absorbing structure to cushion the occupants and fuel tanks in the event of a rear end collision. Forming portions of the tail structures from conical structures, for example, allows for progressive crumpling of the structure during an impact, thereby allowing for replacement of only the damaged segments after a collision.

Passenger Compartment

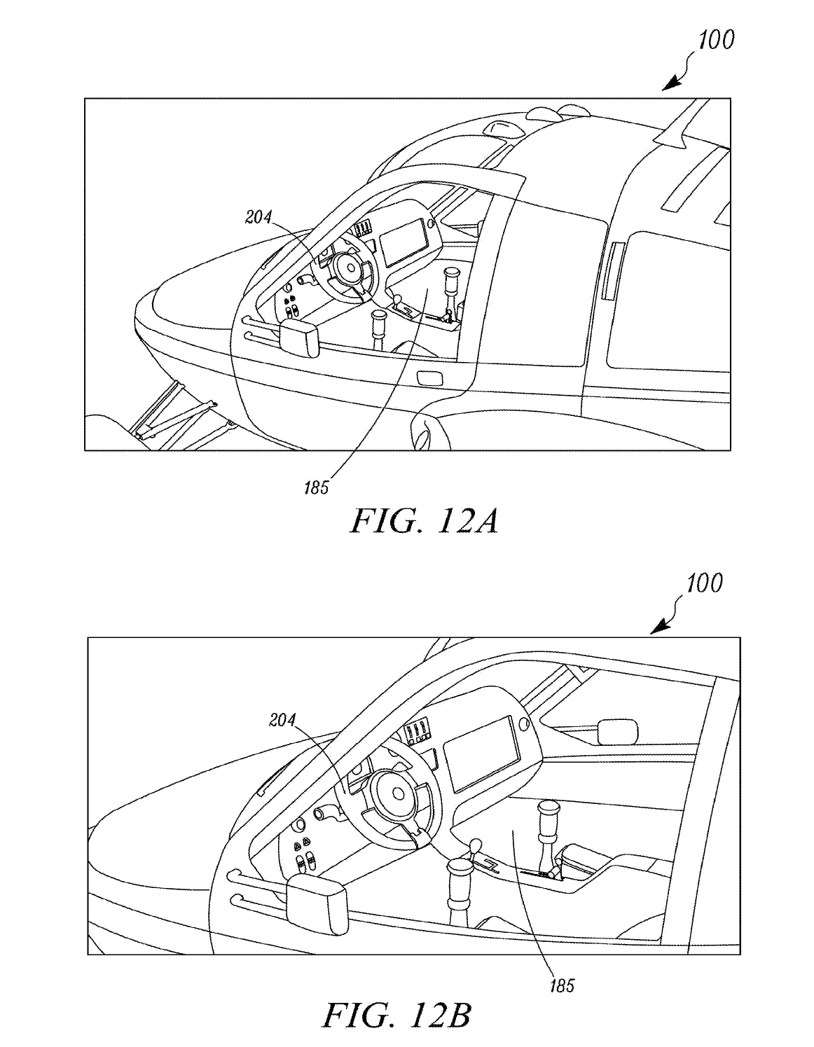

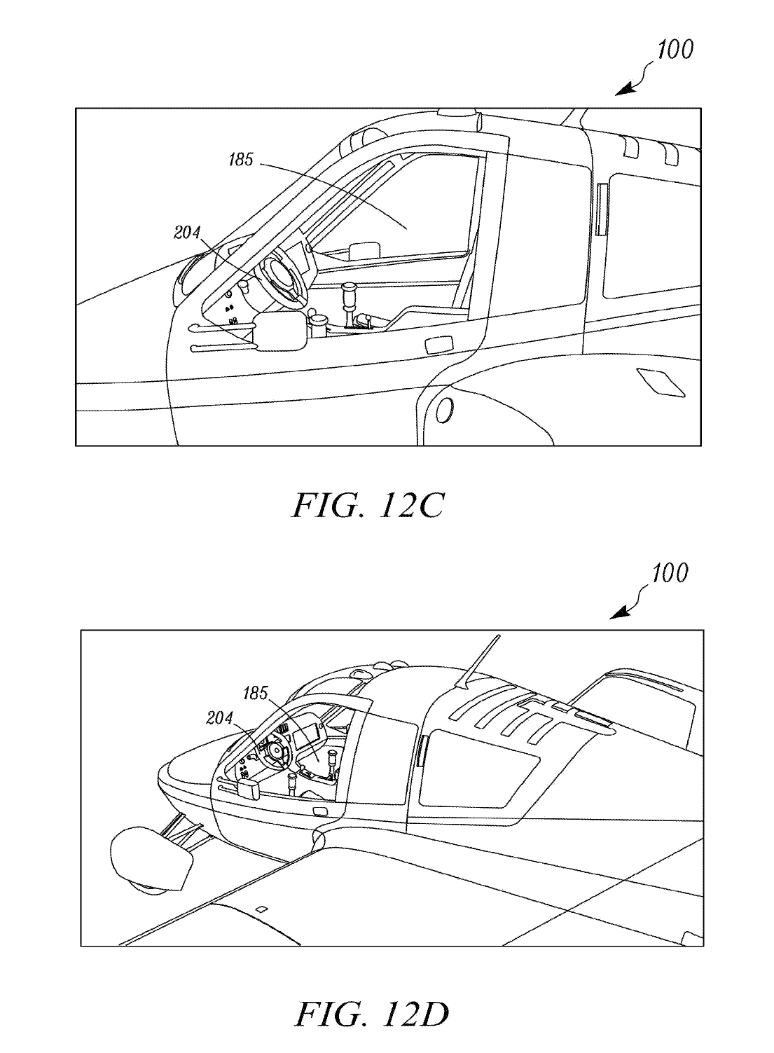

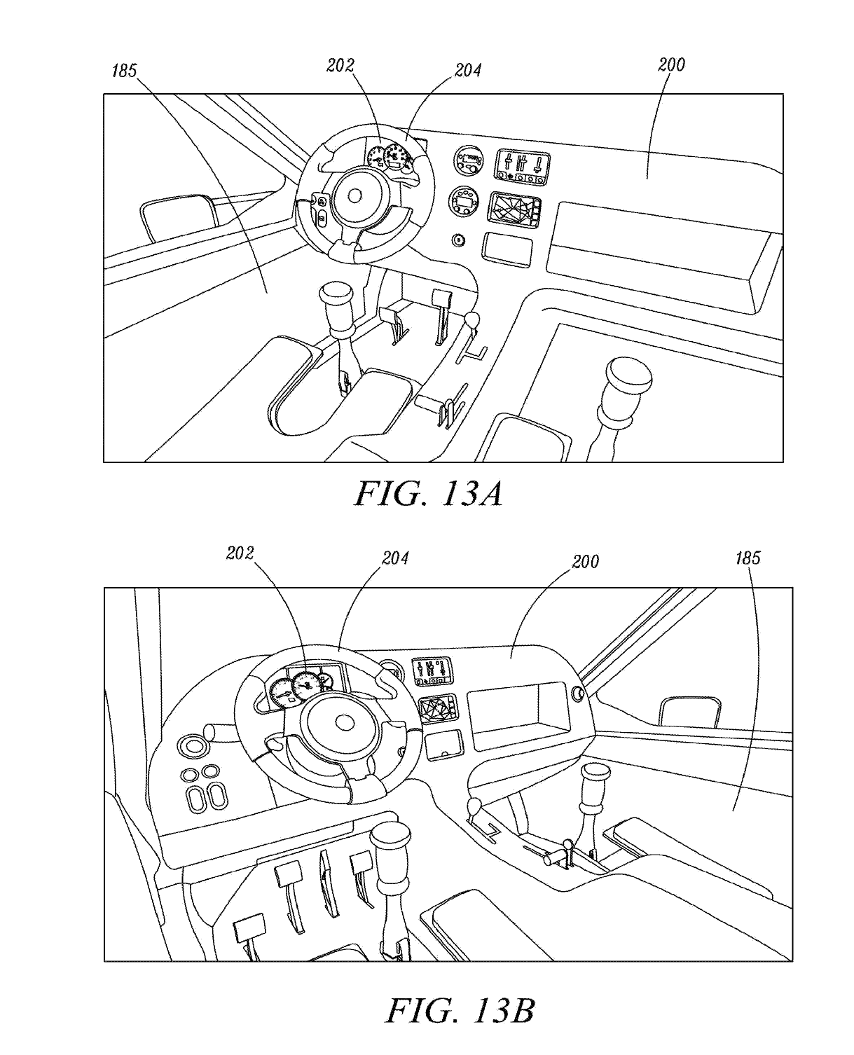

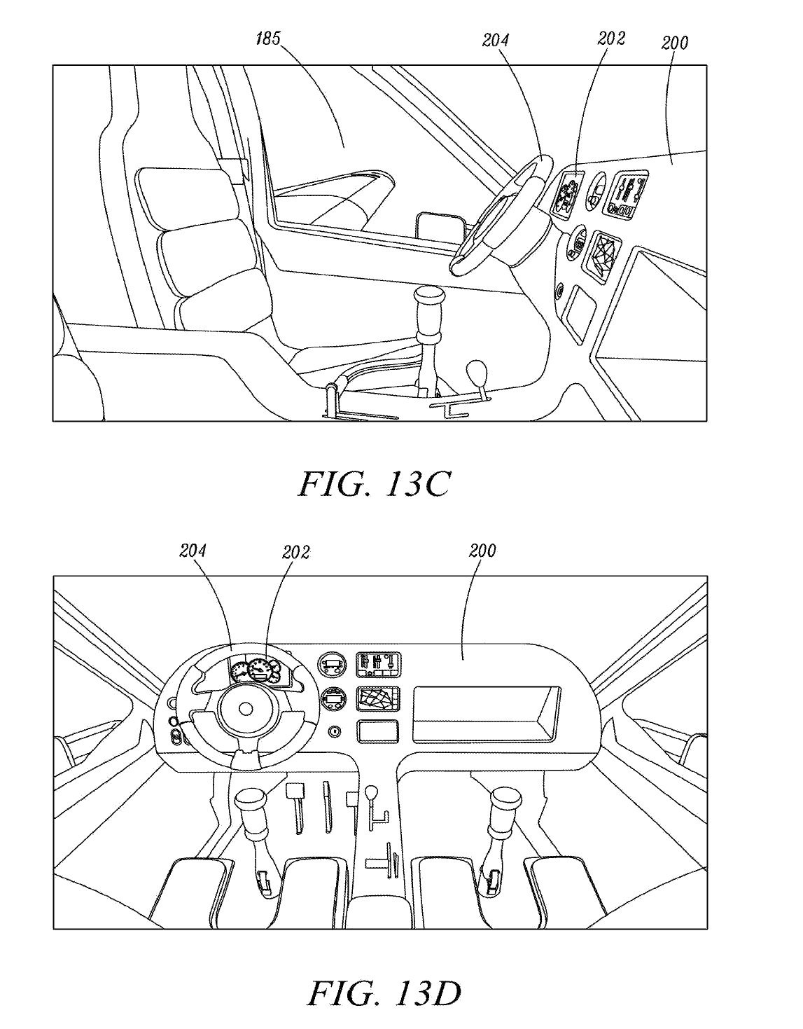

FIGS. 12A to 13D show the exemplary passenger compartment 185 for the roadable aircraft vehicle 100. The passenger compartment 185 may provide sufficient room for an operator and at least one passenger, and houses the vehicle controls and displays for operation of the vehicle 100 by the vehicle operator. The passenger compartment 185 may also provide safety protection for any passengers in the event of a collision.

Dimmable Display

One embodiment of the invention may include the use of a single indicator gauge display screen 202 that may be configured to selectively display either automotive indicators (e.g., a speedometer, a revolutions-per-minute counter, etc.) or flight indicators (e.g., flight speed, altitude, etc.) as required. Providing such display 202 may significantly reduce the number of dials and indicators needed in the passenger compartment 185, thereby simplifying a dashboard 200 and reducing the number of possible distractions to an operator.

National Highway Traffic Safety Administration (NHTSA) regulations require that one must be able to dim the lights in the dash board 200 and associated equipment to a level that is barely visible at night. At the same time, certain indicators must not be dimmable to a level that cannot be seen during bright sunlight. An example is that the warning lights should not be dimmable, but the speedometer must be. This requirement can be problematic for indicator display systems utilizing a single LCD screen having only one backlight control.

To solve this problem, various embodiments of the invention include the LCD screen 202 (display screen 202) adapted to change the graphic images (such as the speedometer) to a darker image, rather than having to dim the LCD backlight. Such systems may result in the screen 202 being effectively dimmed while still allowing for bright warning lights to be displayed as needed if needed. In an alternative embodiment, one or more light sensors may be used to detect the ambient light within the passenger compartment 185 of the vehicle 100 and only allow the LCD to dim to a level that is viewable. For example, in the day, the LCD screen 202 will remain mostly bright, but at night, you would be able to dim the screen 202 to a lower level.

Repositionable Gauges

Since vehicle operators come in varying sizes, it is difficult to position the gauges behind a steering wheel 204 so that everyone, regardless of size, may see the gauges. One solution is to create a tilt steering wheel column. This may allow the steering wheel 204 to be positioned so that the gauges may be clearly seen. However, tilt steering wheels used in standard automobiles are generally very heavy. As such, adding a tilting steering wheel to the roadable aircraft vehicle 100 may result in the addition of unnecessary additional weight to the vehicle 100 that may significantly impact performance of the vehicle 100 in flight mode. To avoid this, one embodiment of the invention may include the use of repositionable gauges within the passenger compartment 185 of the vehicle 100. As a result, rather than having to provide a tilting steering wheel to allow operators of different sizes to clearly view the performance indication gauges of the vehicle 100 during the flight and/or the automotive mode, the steering wheel 204 may be non-pivotably locked in a single position, thereby saving weight, with the gauges themselves being movable to ensure clear viewing by any operator.

For example, for embodiments of the invention including the single indicator gauge display screen 202 configured to selectively display automotive indicators and/or flight indicators (e.g., a controllable LCD screen 202), the location of specific gauges on the screen 202 may be controlled through the software controlling the display screen 202. In various embodiments, the act of moving the gauges on the LCD screen 202 may be carried out through a menu driven system, through an automatic system that moves the gauges to a pre-defined position based on automatic operator identification—such as, but not limited to, stored operator data and/or a specific Radio-frequency Identification (RFID) tag—and/or through operator driven touch-and-drag movement of the gauges on the LCD screen 202 into their correct position.

Reconfigurable Display

One embodiment of the invention may include a custom arranged visual display for a vehicle operator, thereby allowing for the customized selection and arrangement of performance indicator gauges on the display screen 202. For example, for a single indicator gauge display LCD screen 202, individual operators may select a gauge layout that they prefer. This may, for example, be one of several pre-defined layouts, or it could be a completely customized layout. The display could be programmed directly on the touch screen 202, or created and uploaded on a PC. In one embodiment, a vehicle manufacturer may provide a number of various layouts for selection by an operator at time of purchase, or later. In addition, the display screen 202 layout may be linked to an operator's personal RFID key tag, thereby allowing for the automatic customization of the display screen 202 for each separate operator.

Ignition Key Sensing

One embodiment of the invention may include a system and method for sensing an ignition key in the ignition of an aircraft vehicle such as, but not limited to, the roadable aircraft vehicle 100, and securing the vehicle 100 when the key is removed. NHTSA regulations require that an automotive vehicle become secure when the user removes the ‘key’ from the vehicle. Securing the vehicle is defined as either preventing forward mobility (i.e., park), or steering (i.e., column lock). This is typically accomplished by using a heavy ignition lock that knows when the key is present or not. The system must also prevent the key from being removed unless the security system has been engaged—for example, an operator can not remove an ignition key without putting the car in park, or the steering column locks automatically when the operator removes the key.

For the roadable aircraft vehicle 100, minimizing weight and reducing the number of user interface elements to simplify operation of the vehicle 100 may be advantageous for both performance and safety reasons. As such, one embodiment of the invention may allow for the securing of the vehicle 100 upon removal of an ignition key without the need for a manual parking brake, a column lock, and/or a heavy ignition system, all of which would add weight and complexity to the vehicle 100. This may be achieved, for example, through the use of an RFID key for the vehicle 100.

NHTSA regulations state that a ‘key’ can be an electronic code such as an RFID tag. When the pilot places their RFID key near the sensor, they are effectively inserting their key into the system. This may allow the vehicle 100 to very easily sense whether the key is present without using a heavy lock cylinder. In the invention, the vehicle 100 may be configured with a key recognition and sensing system such that, when an operator removes the RFID key from near the sensor, an automatically engageable parking brake (e.g., an electrically driven parking brake) will automatically engage. This satisfies the requirements that the vehicle 100 be secure when the key is removed from the vehicle 100 without adding unnecessary complexity and additional heavy systems to the vehicle 100. In one embodiment, safety checks may be programmed in to the system so that if the key is accidently removed while the vehicle 100 is in motion, the brake will not be applied.

Gearbox for Roadable Aircraft Vehicle

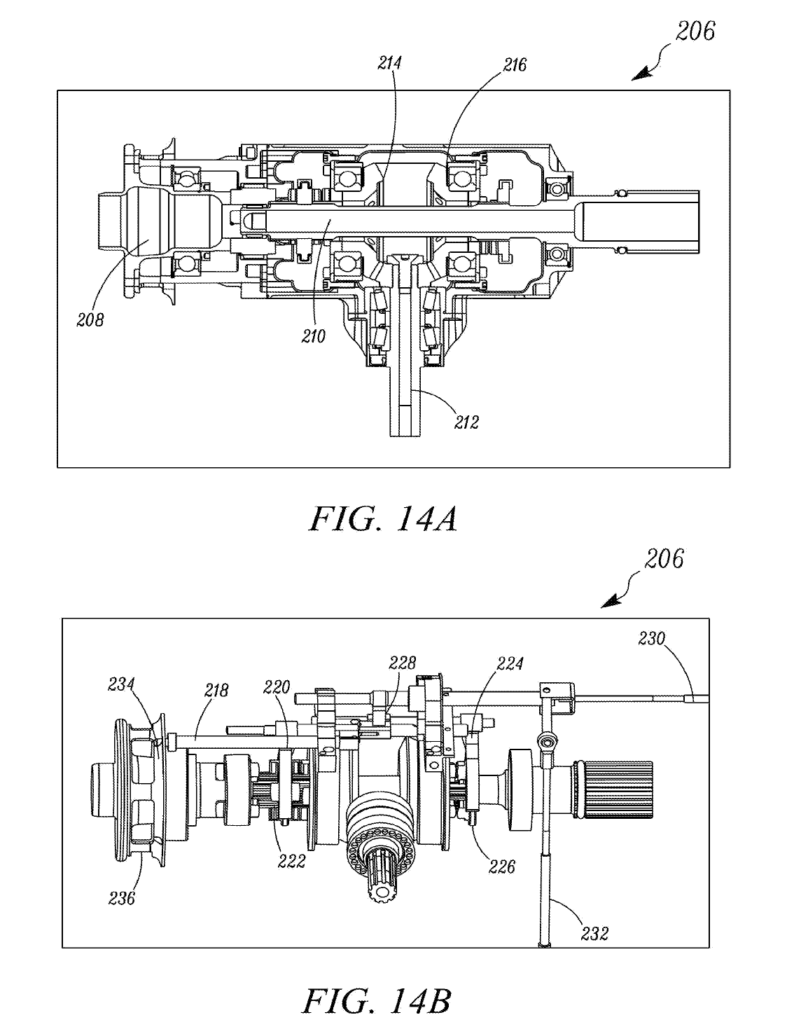

FIGS. 14A and 14B show a gearbox 206 of the roadable aircraft vehicle 100, according to an embodiment of the invention. The gearbox 206 may be used, for example, to couple the engine of the roadable aircraft vehicle 100 to a drive system for the flight mode (e.g., a propeller) or the drive system for the automotive mode (e.g., a continuously variable transmission adapted to drive the wheels 196 of the vehicle 100). In general, weight limitations necessitate the use of only one engine in a Light Sport Aircraft vehicle that may transform into a highway vehicle. This requires a mechanism for transferring power from the engine to either the propeller or the wheels 196 while providing a simple user interface to both shift gears and actuate a propeller locking device.

As shown in the example gearbox 206 of FIGS. 14A and 14B, the gearbox 206 may include components such as, but not limited to, a propeller mounting hub 208, a splined through-shaft 210, a power takeoff shaft and pinion gear 212, a forward drive gear 214 and a reverse drive gear 216, a propeller locking cylinder 218, a propeller/forward gear selector fork and shift rail 220, a propeller/forward gear shift dog ring 222, a reverse gear selector fork and shift rail 224, a reverse gear shift dog ring 226, a selector rail with finger 228, a gear selector push-pull cable 230, a rail selector push-pull cable 232, a spring loaded locking pin 234, and a propeller lock plate 236.

The gearbox 206 may provide for manual selection between a neutral position, driving the propeller, and turning the wheels 196 in forward or reverse. In order to increase the reliability of the vehicle 100 in the air, in one embodiment the power to the propeller does not pass through any gears. Power to the wheels 196 goes through a geared power takeoff (e.g., a right angle geared power takeoff). The right angle may be necessary, in certain embodiments, because the rotational planes of the propeller and drive wheels 196 are orthogonal. The gear box 206 may utilize racing style shift dog rings 222, 226 to select between gears. The shift rings slide 222, 226 on splines 210 on the main through shaft, and are manipulated by forks 220, 224 attached to the shifting apparatus. The gear box 206 may also include a propeller lock mechanism that is mechanically tied to the shifting apparatus, which forces the propeller to be locked and unable to spin when the gear box 206 is in any position other than engaged with the propeller. Push-pull cables 230, 232 may be used to select shift rails 220, 224 and to shift gears 214, 216. The push-pull cables 230, 232 may be actuated from the cockpit via a shift lever.

In operation, the shift rail/finger 220, 224, 228 may be actuated axially by the first push-pull cable 230 to select gears 214, 216 and actuated rotationally by a second push-pull cable 232 to select between forward/propeller and reverse shift rails. When a given rail is selected, first actuating cable 232 moves one of the shift forks 220, 224, which in turn engage the dog rings 222, 226 into the desired positions. The propeller lock drives the propeller locking cylinder 218 into one of a number of (e.g., 3 or 4, depending on number of blades on prop) holes in a lock plate, with a spring loaded pin aiding engagement.

Propeller Locking Mechanism

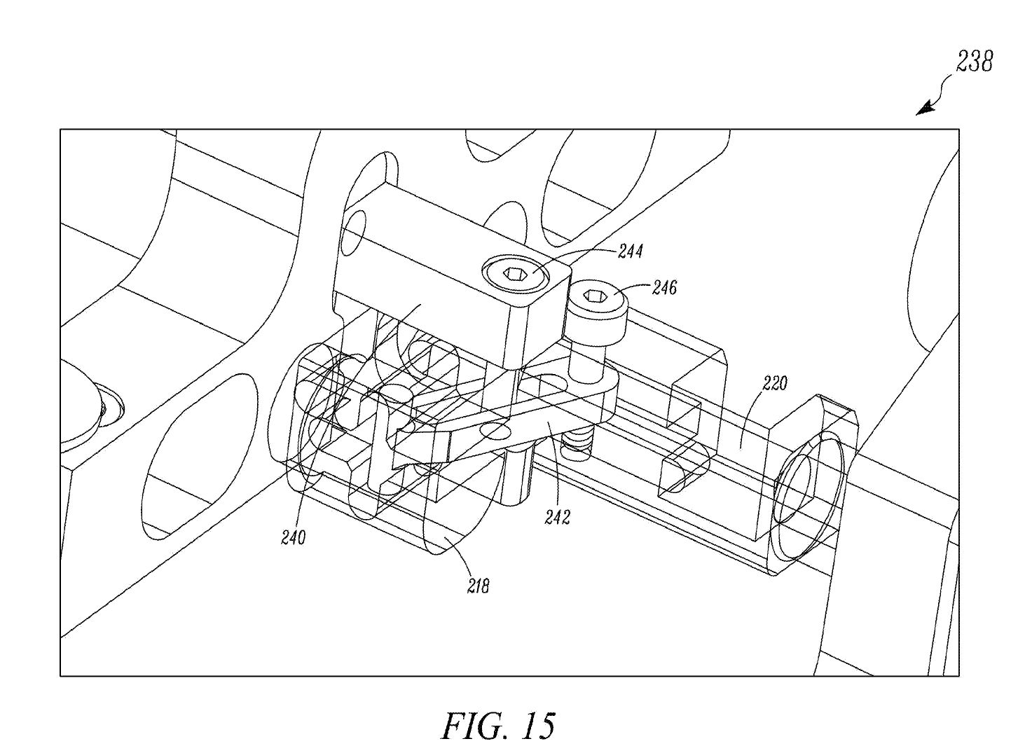

FIG. 15 shows a propeller locking mechanism 238, according to an embodiment of the invention. When the propeller is disengaged, it may be free to spin and pinwheel when the vehicle 100 is operating on the ground. To avoid this, one embodiment of the invention may include the propeller locking mechanism 238 to both arrest the pinwheeling nature of the propeller, as well as orient the blades to maximize their protection from road debris and ground strike and/or to minimize overall vehicle height when the vehicle 100 is operating on the ground. The propeller may, for example, be locked in a position that provides maximum ground clearance between the propeller and the ground when in the automotive mode to reduce the chance of damage to the propeller when driving.

In the example propeller locking mechanism 238 of FIG. 15, the propeller locking mechanism 238 may include a locking linkage mount 240, the propeller locking cylinder 218 (transparent in FIG. 14 to aid visualization), the propeller/forward shift rail (transparent in FIG. 14 to aid visualization) 220, a locking linkage 242, a linkage supporting shoulder bolt 244, and a linkage pivot shoulder bolt 246. In operation, when the propeller/forward shift rail 220 moves between propeller engagement, neutral and forward gear engagement, the locking linkage 242 forces the propeller locking cylinder 218 to engage and disengage according to a set of requirements including, for example, the requirement that the propeller must be locked when the propeller/forward shift rail 220 is in any position other than propeller engagement. In one embodiment, the linkage design 242 also provides for delayed engagement timing of the propeller locking cylinder 218 in relation to the propeller/forward shift rail 220 to ensure that there is never overlapping engagement between the propeller and the propeller locking cylinder 218. This ensures unintentional engine start while the propeller is engaged will not result in damage of components.

Shift Lever Mechanism

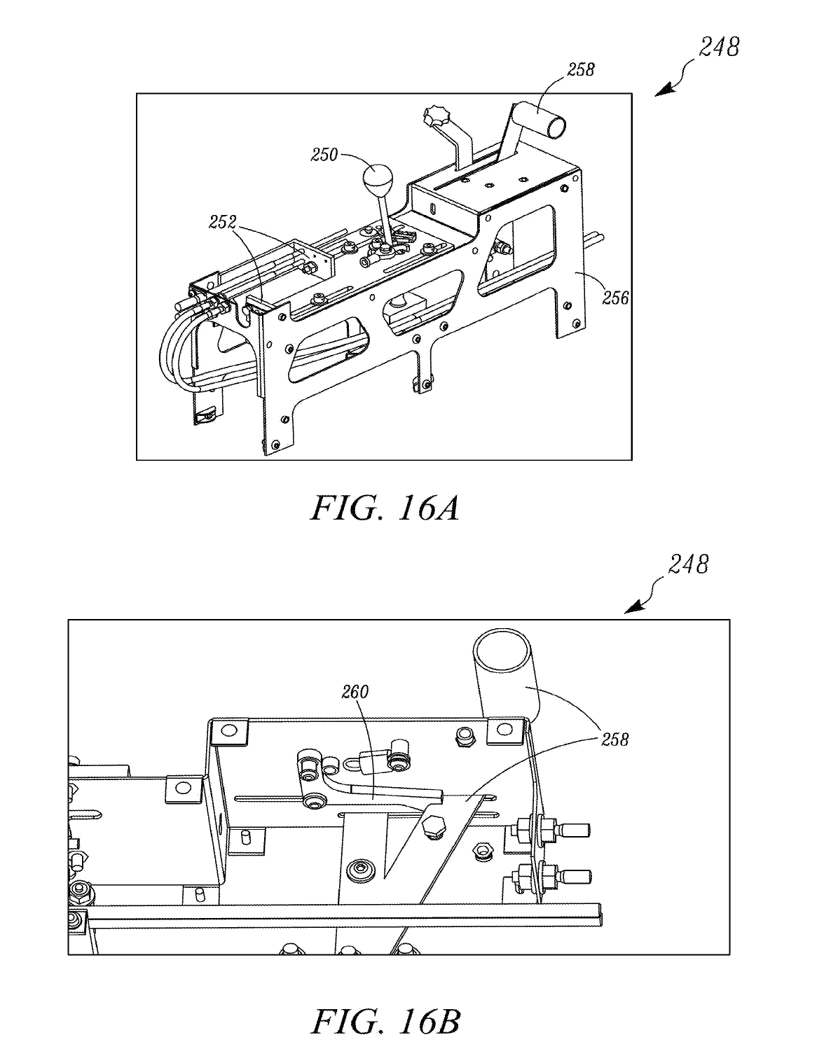

FIGS. 16A and 16B show a shift lever mechanism 248 for the roadable aircraft vehicle 100, according to an embodiment of the invention. The shift lever mechanism 248 may be used, for example, to control the drive system in the automotive mode (e.g., shift gears), switch the drive system between the automotive and the flight mode, and/or actuate the folding/lock system of the wing 102. In one embodiment, a shift lever 250 has forward, neutral, and reverse as well as propeller positions, where the propeller position also controls other aircraft functions, such as allowing the pilot to deploy the wings 102, switching the throttle to the appropriate idle setting, deploying the rear-view mirrors, and/or other functions required for entering or leaving the flight mode. The same shift lever 250 may also lock the throttle used for flight at idle when in forward, neutral or reverse. This may allow for a compact user interface that may be easily repeated by the pilot/driver, with fewer opportunities for procedural errors on the part of the operator.

In one embodiment, the shift lever mechanism 248 may include the shift lever 250, cable mounting points 252 for wings locks, shift actuation and other functions, a mounting structure 256, a throttle lever 258, and a mechanical spring loaded throttle lock mechanism 260.

In operation, when the shift lever 250 moves, the shift lever 250 operates cables (such as the cables 230, 232) mounted to the mounting points 252. When the shift lever 250 is moved out of propeller engagement position, the spring loaded throttle latch 260 is released, and when the throttle lever 258 is brought to idle, the locking mechanism 260 holds it there mechanically. The lever lock 260 is released only when the shift lever 250 is again moved to the propeller engagement position, and is pulled and held away from the throttle lever 258 by a wire attached to the shift lever 250. As such, the automotive shift lever 250 may be used to control engagement and disengagement of the propeller in addition to controlling the drivetrain of the vehicle 100 in the automotive mode.

Roadable Aircraft vehicle Drive System

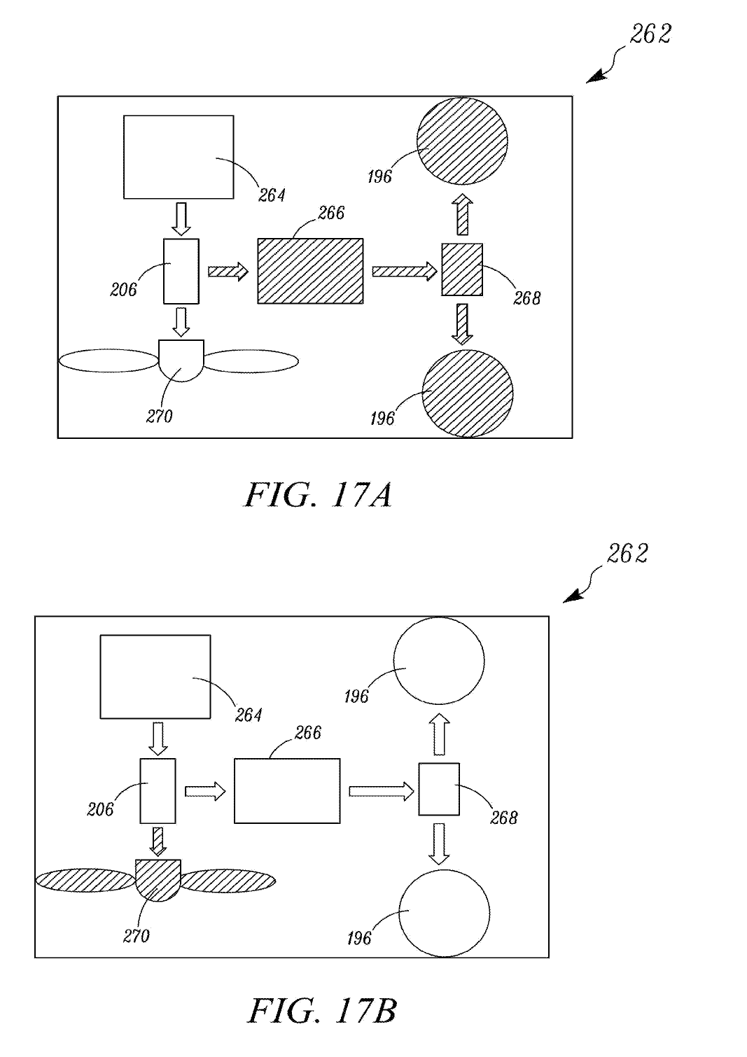

FIGS. 17A and 17B show a drive system 262 for the roadable aircraft vehicle 100 in both the automotive mode and the flight mode, according to an example embodiment of the invention. In this embodiment, the vehicle drive system 262 includes the engine 264 (e.g., a 100 hp Rotax 912S engine, manufactured by BRP-Rotax GmbH & Co. KG, Austria), the gearbox 206, a transmission 266, such as, but not limited to, a continuously variable transmission, a differential 268 for the automotive mode and a control system for switching between the flight mode and the automotive mode. In certain embodiments, the vehicle drive system 262 may include a user interface including a display for controlling the drive system 262 in the automotive mode (including the steering wheel 204) and in the flight mode (including a control stick). The continuously variable transmission 266, which is driven by the right angle power takeoff of the gearbox 206, does not, in one embodiment, provide a “park” setting for the vehicle 100. Thus, a parking brake, or pawl, is electrically actuated by a non back-drivable motor/gear head and may, for example, be triggered when the key is removed from the vehicle 100.

When in the flight mode, as shown in FIG. 17A, the engine 264 is coupled to one or more propellers 270 through the gearbox 206. When in the automotive mode, as shown in FIG. 16B, the gearbox 206 is disengaged from driving the propeller 270 and instead engages the continuously variable transmission 266 which is coupled, through the differential 268, to the wheels 196 of the vehicle 100. As a result, by selectively controlling the coupling of the gearbox 206, the engine 264 may be used to power the vehicle 100 in both the flight and the automotive modes. In one embodiment, the drive system 262 may include a control element coupling various automotive and flight control actuators (e.g., a gas pedal and throttle) to ensure that automotive control features, such as the gas pedal, cannot be actuated when the vehicle 100 is in the flight mode, and aircraft control features cannot be actuated when the vehicle 100 is in the automotive mode.

In one embodiment of the invention, the drive system 262 may include a data storage unit (e.g., a “black box” data recorder) adapted to record control and/or performance data during the flight mode and/or the automotive mode. The data storage unit may, for example, be part of a computer storage and control system for the vehicle. In one embodiment, the vehicle 100 may also include a transponder that may operate in both the flight and the automotive modes to provide a locator device for the vehicle 100. In various embodiments, the drive system 262 may allow for the combined use of automotive and aircraft avionics features to reduce the complexity of the control system 268 for the vehicle 100 in both the flight and the automotive mode.

Stowable Flight Control Stick

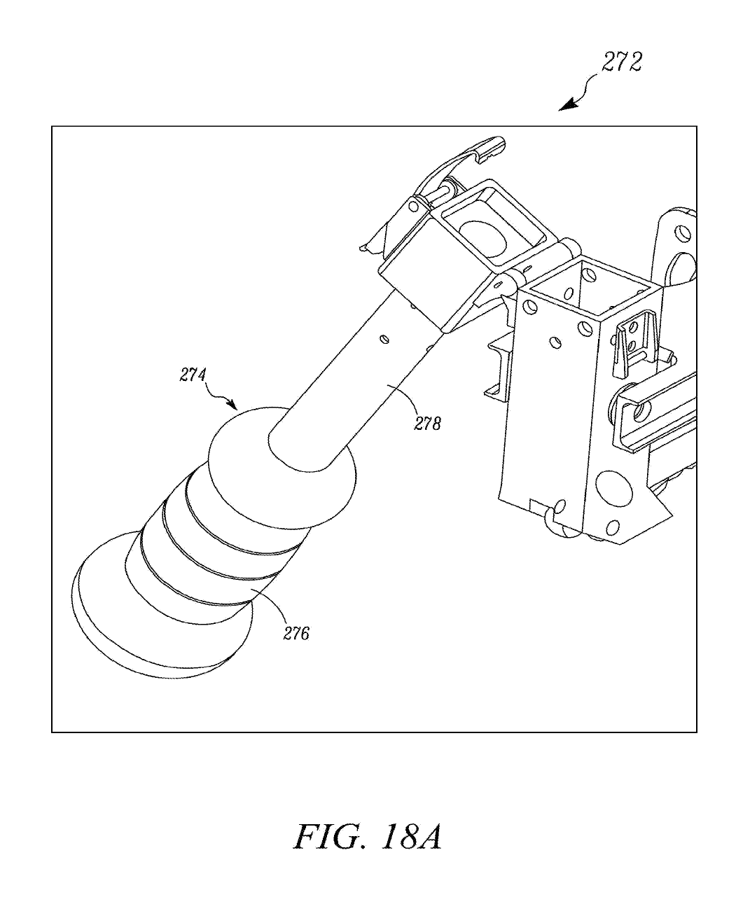

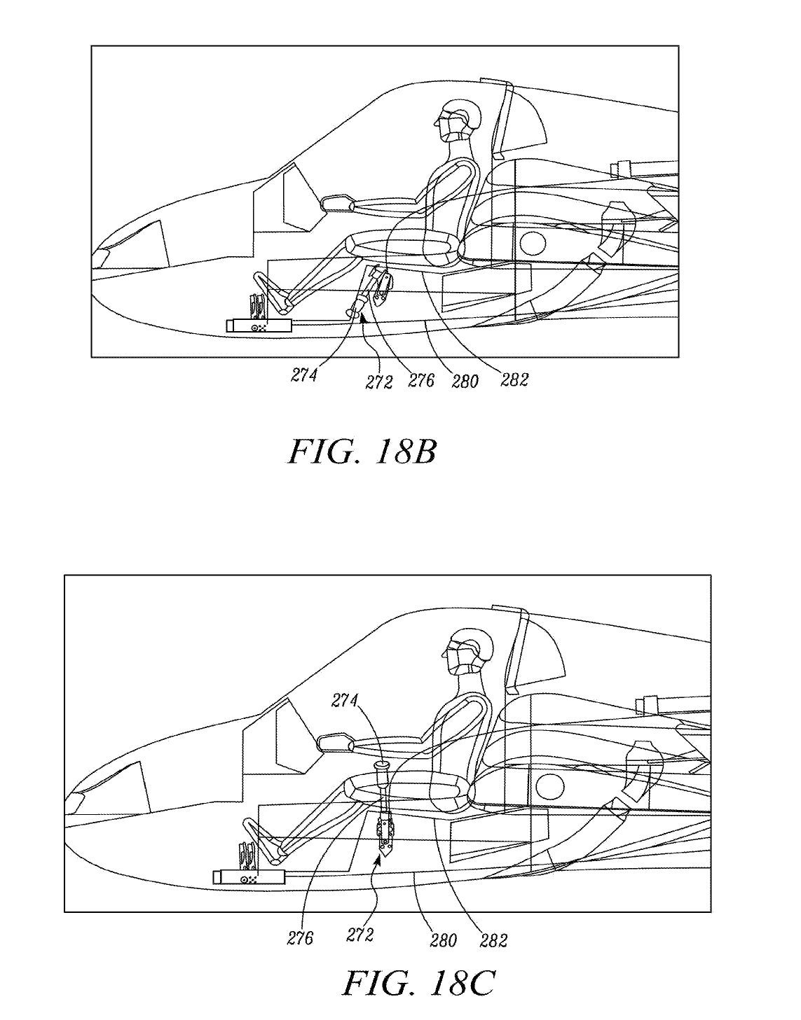

FIG. 18A shows a stowable control stick 272 for the roadable aircraft vehicle 100 in a stowed position, according to an embodiment of the invention. FIGS. 18B and 18C show the stowable control stick 272 positioned within the vehicle passenger compartment 185 in a stowed position and in a deployed position, respectively. The stowable flight control stick 272 for the roadable aircraft vehicle 100 may be stowed during the automotive mode to allow ease of access, ease of use, and safety in the case of an accident when in the automotive mode.

In one embodiment, the control stick 272 for the roadable aircraft vehicle 100 may perform traditionally when the vehicle 100 operates in the flight mode. When transitioning to operate on the ground, the control stick 272 may be folded, or otherwise retracted, to place it out of the way of the operator while the vehicle 100 is operating in the automotive mode. For example, the stowable control stick 272 may include a stick portion 274, including an upper stick 276 and a lower stick 278 that may be releasably latched, and when unlatched folds in half for stowing in the floor in front of the operator. When folded forward into a front wall of a seat pedestal or floor 280 the top of the stick or the upper stick 276 may be below the level of a seat 282 and the control stick 272 itself may be in a position to not interfere with an operator entering and exiting the vehicle 100. When folded, the control stick 272 may not interact with the operator in the case of a collision in both the belted and unbelted scenarios, as per the Federal Motor Vehicle Safety Standards.

In one embodiment, when locked in the stowed position for automotive operation of the vehicle 100, the control stick 272 may maintain the pitch control surface in the proper orientation to display the license plate 156 and also locks the roll control surfaces on the wings 102 so the wings 102 maybe folded without damaging these surfaces.

Steering Centering System

One embodiment of the invention may include a system adapted to ensure that the steerable (i.e., front) wheels 196 of the roadable aircraft vehicle 100 are straight and aligned with the flight path of the vehicle 100 when in the flight mode. Keeping the steerable wheels 196 aligned during landing is important, for example, to ensure the vehicle 100 does not unexpectedly veer out of control upon touchdown.

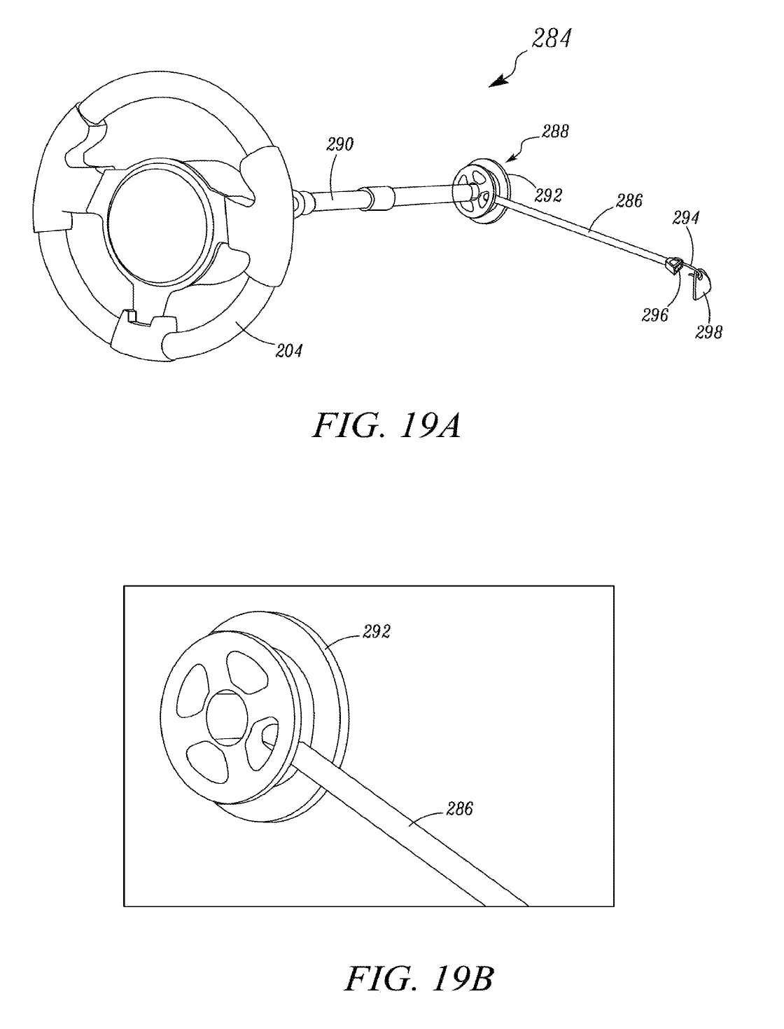

An example steering centering system 284 is shown in FIGS. 19A and 19B. In this embodiment, a cord 286 (such as, but not limited to, a fabric-covered latex rubber cord) and a pulley 288 are attached to a steering column shaft 290 of the roadable aircraft vehicle 100. As the steering wheel 204 is turned, the steering centering pulley 288 rotates along with the steering column shaft 290, which winds the elastomeric cord 286 around the pulley 288, providing a centering force for the wheels 196 while in the flight mode. The neutral position of the system 284 (with the wheels 196 straight ahead) results in no wrapping of the cord 286 around the pulley 288. A raised lip 292 on a far side of the pulley 288 may be included to ensure that the cord 286 does not slip off the pulley 288 during a turn, as shown in FIG. 18B.

In one embodiment, the cord 286 is mounted through a hole in the pulley 288 using a staple clip to permanently mount the cord 286 to the pulley 288, and a hook 294 through a hole 296 on a cord mounting plate 298, which is permanently attached to a structure of the vehicle 100. By utilizing the single elastomeric cord 286 for steering centering (as opposed to a pair of cords), a failure in the system 284 does not result in the steerable wheels 196 being forcibly pulled out of alignment; instead the steering wheel 204 works as it would with the system 284 not installed, and manual alignment of the wheels 196 is easily performed by the pilot of the vehicle 100 prior to touchdown.

In certain roadable aircraft, steering wheels 204 often typically travel through more than one rotation. As a result, the cord 286 may be wrapped multiple times around the pulley 288. The tension in the system 284 may be adjusted by changing the length or stiffness of the cord 286, or by moving the fixed attachment point. The amount of restoring force may increase as the cord 286 winds up on the pulley 288. This may, for example, be adjusted by changing the ratio of the length of wrapped cord 286 to the total length of the cord 286 so that the effect of the cord 286 during driving is unobtrusive. In an alternative embodiment, the steering wheel 204 may be biased to a center position by using, for example, an electric power steering assist system with a position encoder and a torque control to provide a restoring torque on the steering wheel 204 if it is displaced from center.

Federal Motor Vehicle Safety Standards

The National Highway Traffic Safety Administration has a legislative mandate under Title 49 of the United States Code, Chapter 301, Motor Vehicle Safety, to issue Federal Motor Vehicle Safety Standards (FMVSS) and Regulations to which manufacturers of motor vehicle and equipment items must conform and certify compliance. These Federal safety standards are regulations written in terms of minimum safety performance requirements for motor vehicles or items of motor vehicle equipment. These requirements are specified in such a manner “that the public is protected against unreasonable risk of crashes occurring as a result of the design, construction, or performance of motor vehicles and is also protected against unreasonable risk of death or injury in the event crashes do occur.”

Various embodiments of the invention described herein include components and systems that may be incorporated into the roadable aircraft vehicle 100 to ensure that the vehicle 100 meets the required performance and safety standards required by the FMVSS when in the automotive mode, while not negatively impacting the performance of the vehicle 100 during the flight mode. In fact, various embodiments of the invention include components and systems that may provide improved safety and/or performance of the roadable aircraft vehicle 100 in both the automotive mode and the flight mode.

One embodiment of the invention may include a system for providing controls, telltales, and indicators for the roadable aircraft vehicle 100 when in the automotive mode. This may, for example, include a user interface display with two modes (i.e., an aircraft glass cockpit display when in the flight mode and an automotive information display when in the automotive mode), so that the same space within the passenger compartment/cockpit 200 may be utilized to provide appropriate information to an operator at all times. As a result, the dashboard 200 of the passenger compartment 185 may remain uncluttered, thereby reducing possible distractions to the operator during either the flight mode or the automotive mode. In one embodiment, the user interface may include the touch screen 202 (e.g., LCD screen 202) that automatically switches from the automotive mode to the flight mode or wing change mode, with an operator then able to select different sub-modes through manipulation of the touch screen 202. In one embodiment, when in the automotive mode, even if the user interface screen is dimmed, the dummy lights still come on at full brightness.

One embodiment of the invention may include a transmission shift lever sequence, starter interlock, and transmission braking effect including an interlock for the vehicle 100 when in the flight mode so that a parking brake or transmission lock is applied before an ignition key may be removed from the ignition.

One embodiment of the invention may include the vehicle 100 having a transmission that does not include a parking brake or a lock up mechanism when in the flight mode. In this embodiment an electrically actuated parking brake that actuates when the key is removed may be utilized to meet the required braking standards. One embodiment may include the vehicle drive system 262 having the shift lever 250 that has forward, neutral, and reverse gears, as well as a propeller actuation mode, where the flight mode also controls other aircraft functions, such as allowing the pilot to deploy the wings 102, switch the throttle to the appropriate idle setting, deploy the rear-view mirrors 170, and other functions required for entering or leaving the flight mode.

One embodiment of the invention may include the vehicle 100 having components meeting required lamp, reflective device, and associated equipment standards. This may, for example, include combination headlights and landing lights, interlocks to ensure that the lights are linked to automotive mode, and/or marker light that fold into the folding wing 102 during the extension of the wings 102. The vehicle 100 may also include a combination retractable license plate 156 and reverse light system 158. The marker lights 150 (from the optical wing marking system 150) may be located on top of the wing fold 152 and fold into the wing 102 when in the flight mode. The vehicle 100 may also include tail marker lights and reflectors positioned on the underside of the elevator, so they are only visible when elevator is turned upwards for the automotive mode.

One embodiment of the invention may include the vehicle 100 having accelerator control systems such as a linked accelerator pedal and the throttle lever 258, with the throttle lever 258 being automatically disabled in the automotive mode. In one embodiment, the throttle lever 258 is locked out in the automotive mode, e.g., with a latch, and the idle level is different in the automotive/flight modes to compensate for the lower inertia without the propeller 270 attached to the engine.

The vehicle 100 may further include occupant crash protection systems such as crumple zones 186, safety cage 184, lightweight beams, dash mounted airbags, seatbelts designed for higher impacts, angled impacts, and/or front impact airbag. These occupant protection systems may be useful both in the automotive mode and in the flight mode during descent under a ballistic recovery system (BRS) parachute in nose down attitude. In one embodiment, the crumple zone 186 is formed to provide minimal additional weight in order to reduce its impact on the performance of the vehicle 100 during normal operation.

In one embodiment, side impact protection may be incorporated into a vehicle such as the roadable aircraft vehicle 100 to protect the passengers against side impact collisions.

This may be achieved, for example, by using the folded wing structures 102 of the roadable aircraft vehicle 100 as energy absorbers in side impact. In one embodiment, the folded wing structure 102 is positioned immediately aft of the passenger compartment 185 to be used as crush space and energy absorption in a side impact. Wing panels 120, 122 may be replaceable to minimize damage to the fuselage. A high rocker beam allows a lighter weight door because the rocker, not the lower part of the door, takes side impact loads. The door structure may have a single cross beam directly connecting the latch and upper hinge for impact protection. The lower hinge is a light hinge to keep the door aligned during regular use.

To maintain fuel system integrity, one embodiment of the invention may include a vehicle, such as the roadable aircraft vehicle 100, with a protected fuel system to minimize leakage in the event of a crash. This may, for example, include the use of tail booms as collapsible energy absorbing structures for rear impact. These tail booms may be modular or replaceable to limit damage in rear impact. In operation, the tail booms or tail structure may include a collapsible energy absorbing structure to cushion the occupants and fuel tanks in the event of a rear end collision. Conical structure, for example, will allow for progressive crumpling and replacement of only the damaged segments.

It should be understood that alternative embodiments, and/or materials used in the construction of embodiments, or alternative embodiments, are applicable to all other embodiments described herein.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A roadable aircraft vehicle, comprising:
a vehicle drive system comprising an engine and gearbox selectively engageable with an automotive driveline and at least one propeller;
a user interface including a display for controlling the drive system in an automotive mode including a steering wheel and in a flight mode including a control stick;
a control system for switching between the flight mode and the automotive mode; and
means for locking the propeller during the automotive mode.

2. The vehicle of claim 1, wherein the propeller is lockable in a set position adapted to maximize ground clearance during the automotive mode.

3. The vehicle of claim 1, wherein the automotive driveline comprises a continuously variable transmission.

4. The vehicle of claim 1, wherein the control stick is adapted to pivot into a stowed position during the automotive mode.

5. The vehicle of claim 1, wherein the control stick is adapted to telescopingly collapse into a stowed position during the automotive mode.

6. The vehicle of claim 1, wherein the control system switches between flight mode and automotive mode by alternatively coupling the gearbox to the automotive driveline for the automotive mode and coupling the gearbox to the propeller for the flight mode.

7. The vehicle of claim 1, further comprising a folding wing.

8. The vehicle of claim 7, wherein the control system further comprises means for deploying and retracting the folding wing.

9. The vehicle of claim 1, wherein control system further comprises:
means for disabling an automotive gas pedal during the flight mode; and
means for disabling a throttle during the automotive mode.

10. The vehicle of claim 8, wherein the means for deploying and retracting the folding wing comprises a folding mechanism activated by a manipulation of an automotive gear shift lever.

11. The vehicle of claim 1, further comprising a data storage unit adapted to record control and performance data during at least one of the flight mode and the automotive mode.

12. The vehicle of claim 1, further comprising a transponder.

13. The vehicle of claim 1, wherein the display is adapted to display selectively both automotive control data and flight control data.

14. The vehicle of claim 1, wherein the display comprises a touch-screen.

15. The vehicle of claim 1, further comprising at least one stabilator and means for deflecting the stabilator to provide a down-force during the automotive mode.

16. The vehicle of claim 1, further comprises an electronically actuated parking brake.

17. The vehicle of claim 16, wherein the electronically actuated parking brake activates upon removal of an ignition key.

18. An airfoil having a nominal profile, the airfoil comprising:
a leading edge;
a trailing edge;
an upper surface extending from the leading edge to the trailing edge; and
a lower surface extending from the leading edge to the trailing edge and having a substantially flat portion extending over at least about 50% of a chord length of the airfoil, wherein the airfoil has a moment coefficient magnitude of less than about 0.045 and a maximum lift coefficient of greater than about 1.95.

19. The airfoil of claim 18, wherein the nominal profile conforms substantially with Cartesian coordinate values of X, Y set forth in Table 1, wherein X and Y are non-dimensional distances which, when connected by smooth continuing arcs, define airfoil profile sections.

20. A folding wing comprising:
an inner section extendable from a fuselage of an aircraft, the inner section having:
a root end pivotably couplable to the fuselage through a first pivoting mechanism, and;
a distal end;
an outer section pivotably coupled to the inner section distal end by a second pivoting mechanism; and
a folding mechanism adapted to articulate the first pivoting mechanism and the second pivoting mechanism to move the wing between a stowed configuration and a deployed configuration, at least one of the first pivoting mechanism and second pivoting mechanism comprising a four-bar linkage.

21.-40. (canceled)
